(19) United States
(12) Patent Application Publication
(10) Pub. No.: US 2019/0055150 A1
(43) Pub. Date: Feb. 21, 2019

(54) HOMOGENEOUS QUARTZ GLASS FROM PYROGENIC SILICON DIOXIDE GRANULATE

(71) Applicant: Heraeus Quarzglas GmbH & Co. KG, Hanau (DE)

(72) Inventors: Heinz FABIAN, Grossostheim (DE); Achim HOFMANN, Frankfurt am Main (DE); Michael HÜNERMANN, Alzenau (DE); Matthias OTTER, Hamm (DE); Thomas KAYSER, Leipzig (DE)

(73) Assignee: Heraeus Quarzglas GmbH & Co. KG, Hanau (DE)

(21) Appl. No.: 16/061,185

(22) PCT Filed: Dec. 16, 2016
(86) PCT No.: PCT/EP2016/081505

§ 371 Date: Nov. 9, 2018

(30) Foreign Application Priority Data
Dec. 18, 2015 (EP) 15201086.4

(51) Int. Cl. C03B 20/00; C03B 19/02; C03C 3/06; C01B 33/12

(52) U.S. Cl. CPC C03B 20/00; C01P 2006/14; C03C 3/06; C01B 33/12; C03B 2201/04; C03C 2201/11; C03C 2201/32; C03C 2201/23; C03C 2203/10; C01P 2006/80; C01P 2006/12; C01P 2006/11; C01P 2004/61; C01P 2004/51; C03B 19/02

(57) ABSTRACT

One aspect relates to a process for the preparation of a quartz glass body, including providing a silicon dioxide granulate composed of a pyrogenic silicon dioxide powder, making a glass melt out of the silicon dioxide granulate and making a quartz glass body out of at least part of the glass melt. The quartz glass body has an OH content of less than 10 ppm, a chlorine content of less than 60 ppm and an aluminium content of less than 200 ppb. One aspect also relates to a quartz glass body which is obtainable by this process. Furthermore, one aspect relates to a formed body and a structure, each of which is obtainable by further processing of the quartz glass body.

The invention relates to a process for the preparation of a quartz glass body comprising the process steps i.) Providing a silicon dioxide granulate from a pyrogenic silicon dioxide powder, ii.) Making a glass melt out of the silicon dioxide granulate and iii.) Making a quartz glass body out of at least a part of the glass melt, wherein the quartz glass body has an OH content of less than 10 ppm, a chlorine content of less than 60 ppm and an aluminium content of less than 200 ppb. Furthermore, the invention relates to a quartz glass body obtainable by this process. Furthermore, the invention relates to a formed body and a structure, each of which is obtainable by further processing of the quartz glass body.

### BACKGROUND OF THE INVENTION

Quartz glass, quartz glass products and products which contain quartz glass are known. Likewise, various processes for the preparation of quartz glass and quartz glass bodies are already known. Nonetheless, considerable efforts are still being made to identify preparation processes by which quartz glass of even higher purity, i.e. absence of impurities, can be prepared. In many areas of application of quartz glass and its processed products, high demands are made, for example in terms of homogeneity and purity. This is the case, inter alia, for quartz glass which is used in production steps in the fabrication of semiconductors. Here, every impurity of the glass body can potentially lead to defects in the semiconductor and thus to rejects in the fabrication. The varieties of high purity quartz glass which are employed in these processes are therefore laborious to prepare. These are valuable.

Furthermore, there is a market requirement for the above mentioned high purity quartz glass and products derived therefrom at low price. Therefore, it is an aspiration to be able to offer high purity quartz glass at a lower price than before. In this connection, both more cost-efficient preparation processes as well as cheaper sources of raw materials are sought.

Known processes for the preparation of quartz glass bodies comprise melting silicon dioxide and making quartz glass bodies out of the melt. Irregularities in a glass body, for example through inclusion of gases in the form of bubbles, can lead to a failure of the glass body under load, in particular at high temperatures, or can preclude its use for a particular purpose. Impurities in the raw materials for the quartz glass can lead to cracks, bubbles, streaks and discolorations in the quartz glass. Impurities in the glass body can also be released and transferred to the treated semi-conductor components. This is the case, for example, in etching processes and leads to rejects in the semi-conductor billets. A common problem associated with known preparation processes is therefore an inadequate quality of quartz glass bodies.

A further aspect relates to raw materials efficiency. It appears advantageous to input quartz glass and raw materials, which accumulate elsewhere as side products, into a preferably industrial process for quartz glass products, rather than employ these side products as filler, e.g. in construction or to dispose of them as rubbish at a cost. These side products are often separated off as fine dust in filters. The fine dust brings further problems, in particular in relation to health, work safety and handling.

### Objects

An object of the present invention is to at least partially overcome one or more of the disadvantages present in the state of the art.

It is a further object of the invention to provide a silicon dioxide material that is suitable for components. The term components in particular is to be understood to include components which can be employed for or in reactors for chemical and/or physical treatment steps.

It is a further object of the invention to provide components with a long service life, particularly at high operating temperatures.

It is a further object of the invention to provide which are suitable for specific treatment steps in the processing of semiconductor materials, in particular in solar cell fabrication and semiconductor fabrication in particular in the preparation of wafers. Examples of these specific treatment steps are plasma etching, chemical etching and plasma dopings.

It is a further object of the invention to provide glass components which are free of bubbles or have the lowest possible content of bubbles.

It is a further object of the invention to provide components which have a high contour accuracy. In particular, it is an object of the invention to provide components which do not deform at high temperatures. In particular, it is an object of the invention to provide components which are form stable, even when formed with large size.

It is a further object of the invention to provide components which are tear-proof and break-proof.

It is a further object of the invention to provide components which are efficient to prepare.

It is a further object of the invention to provide components which are cost-efficient to prepare.

It is a further object of the invention to provide components, the preparation of which does not require long further processing steps, for example tempering.

It is a further object of the invention to provide components which have a high transparency. It is a further object of the invention to provide components which have a low opacity.

It is a further object of the invention to provide components which have a high thermal shock resistance. In particular it is an object of the invention to provide components which with large thermal fluctuations exhibit a uniform thermal expansion.

It is a further object of the invention to provide components with a high viscosity at high temperatures.

It is a further object of the invention to provide components which have a high purity and low contamination with foreign atoms. The term foreign atoms is employed to mean constituents which are not purposefully introduced.

It is a further object of the invention to provide components which have a high homogeneity. A homogeneity of a property or of a material is a measure of the uniformity of the distribution of this property or material in a sample.

It is in particular an object of the invention to provide components which have a high material homogeneity. The material homogeneity is a measure of the uniformity of the distribution of the elements and compounds, in particularly of OH, chlorine, metals, in particular aluminium, alkaline earth metals, refractory metals and dopant materials, contained in the component.

It is a further object of the invention to provide a process by which a silicon dioxide material for components can be prepared by which at least part of the above described objects is solved.

A further object is to provide a process by which a silicon dioxide material for components can be prepared in a cost- and time-saving manner.

It is a further object of the invention to provide a process by which a silicon dioxide material for components can be more simply prepared.

It is a further object of the invention to provide a continuous process by which silicon dioxide material for components can be prepared.

It is a further object of the invention to provide a process by which silicon dioxide material for components can be made with a higher speed.

It is a further object of the invention to provide a process by which silicon dioxide material for components can be prepared by a continuous melting and shaping process.

It is a further object of the invention to provide a process by which silicon dioxide material for components can be prepared with a low reject rate.

It is a further object of the invention to provide an automated process by which silicon dioxide material for components can be prepared.

A further object is to improve the processability of components further. A further object is to improve the assemblability of components further.

### Preferred Embodiments of the Invention

A contribution to at least partially fulfilling at least one of the aforementioned objects is made by the independent claims. The dependent claims provide preferred embodiments which contribute to at least partially fulfilling at least one of the objects.
   |1| A process for the preparation of a quartz glass body comprising pyrogenic silicon dioxide comprising the following process steps:
   i.) Providing a silicon dioxide granulate comprising the following process steps:
      I. Providing a pyrogenic, preferably amorphous, silicon dioxide powder;
         wherein further preferably the silicon dioxide powder has the following features:
            a. a chlorine content of less than 200 ppm;
            b. an aluminium content of less than 200 ppb;
      II. Processing the silicon dioxide powder to obtain a silicon dioxide granulate, wherein the silicon dioxide granulate has a greater particle diameter than the silicon dioxide powder;
      wherein further preferably the silicon dioxide granulate is treated with a reactant.
   ii.) Making a glass melt out of the silicon dioxide granulate in an oven;
   iii.) Making a quartz glass body out of at least part of the glass melt;
      wherein the quartz glass body has the following properties:
      A] an OH content of less than 10 ppm;
      B] a chlorine content of less than 60 ppm;
      C] an aluminium content of less than 200 ppb; and
      wherein the ppb and ppm are each based on the total weight of the quartz glass body.
   Amorphous means that the silicon dioxide powder is preferably present in the form of amorphous silicon dioxide particles.
   |2| The process according to embodiment |1|, wherein the warming of the silicon dioxide granulate to obtain a glass melt is effected by a mould melting process
   |3| The process according to one of the preceding embodiments, wherein during the warming for a period t_{T} a temperature T_{T} is maintained which is below the melting point of silicon dioxide.
   |4| The process according to embodiment |3|, characterised by at least one of the following features:
   a.) the temperature T_{T} is in a range from 1000 to 1700° C.;
   b.) the period t_{T} is in a range from 1 to 6 hours.
   |5| The process according to one of embodiments |3| or |4|, wherein the period t_{T} is before the making of the glass melt.
   |6| The process according to one of the preceding embodiments, wherein the quartz glass body obtained in step iii) is cooled at least to a temperature of 1000° C. at a rate of up to 5 K/min.
   |7| The process according to one of the preceding embodiments, wherein the cooling takes place in a temperature range from 1300 to 1000° C. at a rate of not more than 1 K/min.
   |8| The process according to one of the preceding embodiments, wherein the quartz glass body is characterised by at least one of the following features:
   D] a fictive temperature in a range from 1055 to 1200° C.;
   E] an ODC content of less than 5×10¹⁵/cm³;
   F] a metal content of metals different to aluminium of less than 300 ppb; G] a viscosity (p=1013 hPa) in a range from log₁₀ (η (1200° C.)/dPas)=13.4 to log₁₀ (η (1200° C.)/dPas)=13.9 or log₁₀ (η (1300° C.)/dPas)=11.5 to log₁₀ (η (1300° C.)/dPas)=12.1 or log₁₀ (q (1350° C.)/dPas)=1.2 to log₁₀ (η (1350° C.)/dPas)=10.8;
   H] a standard deviation of the OH content of not more than 10%, based on the OH content A] of the quartz glass body;
   I] a standard deviation of the Cl content of not more than 10%, based on the Cl content B] of the quartz glass body;
   J] a standard deviation of the Al content of not more than 10%, based on the Al content C] of the quartz glass body;
   K] a refractive index homogeneity of less than 1×10⁻⁴;
   L] a transformation point Tg in a range from 1150 to 1250° C.;
      wherein the ppb and ppm are each based on the total weight of the quartz glass body.
   |9| The process according to one of the preceding embodiments, wherein the silicon dioxide powder has at least one of the following features:
   a. a BET surface area in a range from 20 to 60 m²/g and;
   b. a bulk density in a range from 0.01 to 0.3 g/cm³;
   c. a carbon content of less than 50 ppm;
   d. a chlorine content of less than 200 ppm;
   e. an aluminium content of less than 200 ppb;
   f. a total content of metals different to aluminium of less than 5 ppm;
   g. at least 70 wt.-% of the powder particles have a primary particle size in a range from 10 to 100 nm;
   h. a tamped density in a range from 0.001 to 0.3 g/cm³;
   i. a residual moisture content of less than 5 wt.-%;
   j. a particle size distribution D₁₀ in a range from 1 to 7 μm;
   k. a particle size distribution D₅₀ in a range from 6 to 15 μm;
   l. a particle size distribution D₉₀ in a range from 10 to 40 μm;
      wherein the ppm and ppb are each based on the total weight of the silicon dioxide powder.
   |10| The process according to one of the preceding embodiments, wherein the silicon dioxide powder can be prepared from a compound selected from the group consisting of siloxanes, silicon alkoxides and silicon halides.
   |11| The process according to one of the preceding embodiments, wherein the processing of the silicon dioxide powder to a silicon dioxide granulate comprises the following steps:
   II.1. Providing a liquid;
   II.2. Mixing the pyrogenic silicon dioxide powder with the liquid to obtain a slurry;
   II.3. Granulating the slurry to obtain a silicon dioxide granulate;
   II.4. Optionally treating the silicon dioxide granulate.
   |12| The process according to one of the preceding embodiments, wherein at least 90 wt. % of the silicon dioxide granulate prepared in step i.) is made from the pyrogenic silicon dioxide powder, based on the total weight of the silicon dioxide granulate.
   |13| The process according to one of the preceding embodiments, wherein the silicon dioxide granulate is characterised by at least one of the following features
   A) a chlorine content of less than 500 ppm;
   B) an aluminium content of less than 200 ppb;
   C) a BET surface area in a range from 20 to 50 m²/g;
   D) a pore volume in a range from 0.1 to 2.5 mL/g;
   E) a bulk density in a range from 0.5 to 1.2 g/cm³;
   F) a tamped density in a range from 0.7 to 1.2 g./cm³;
   G) a mean particle size in a range from 50 to 500 μm;
   H) a carbon content of less than 5 ppm;
   I) an angle of repose in a range from 23 to 26°,
   J) a particle size distribution D₁₀ in a range from 50 to 150 μm;
   K) a particle size distribution D₅₀ in a range from 150 to 300 μm;
   L) a particle size distribution D₉₀ in a range from 250 to 620 μm, wherein the ppm and ppb are each based on the total weight of the silicon dioxide granulate II.
   |14| A quartz glass body obtainable by a process according to one of the preceding embodiments.
   |15| A quartz glass body comprising pyrogenic silicon dioxide, wherein the quartz glass body has the following features:
   A] an OH content of less than 10 ppm;
   B] a chlorine content of less than 60 ppm; and
   C] an aluminium content of less than 200 ppb;
   wherein the ppb and ppm are each based on the total weight of the quartz glass body.
   |16| The quartz glass body according to embodiment |15|, wherein the quartz glass body is characterised by at least one of the following features:
   D] a fictive temperature in a range from 1055 to 1200° C.;
   E] an ODC content of less than 5×10¹⁵/cm³;
   F] a metal content of metals different to aluminium of less than 300 ppb;
   G] a viscosity (p=1013 hPa) in a range from log₁₀ (η (1200° C.)/dPas)=13.4 to log₁₀ (η (1200° C.)/dPas)=13.9 and/or log₁₀ (η (1300° C.)/dPas)=11.5 to log₁₀ (η (1300° C.)/dPas)=12.1 or log₁₀ (q (1350° C.)/dPas)=1.2 to log₁₀ (η (1350° C.)/dPas)=10.8;
   H] a standard deviation of the OH content of not more than 10%, based on the OH content A] of the quartz glass body;
   I] a standard deviation of the Cl content of not more than 10%, based on the Cl content B] of the quartz glass body;
   J] a standard deviation of the Al content of not more than 10%, based on the Al content C] of the quartz glass body;
   K] a refractive index homogeneity of less than 1×10⁻⁴;
   L] a transformation point Tg in a range from 1150 to 1250° C.;
   wherein the ppb and ppm are each based on the total weight of the quartz glass body.
   |17| A process for the preparation of a formed body comprising the following process steps:
   (1) Providing a quartz glass body according to one of embodiments |15| to |16|, or a quartz glass body obtainable by a process according to one of embodiments III to |131;
   (2) Making a formed body out of the quartz glass body.
   |18| A formed body obtainable by a process according to embodiment |17|.
   |19| A process for the preparation of a structure comprising the following process steps:
   a/ Providing a formed body according to embodiment |18| and a part;
   b/ Joining the formed body with the part to obtain the structure.
   |20| A structure obtainable by a process according to embodiment |19|.
   |21| A use of a silicon dioxide granulate for improving the purity and homogeneity of quartz glass bodies.
   |22| A use of a silicon dioxide granulate for the preparation of components comprising quartz glass for processing in solar cell fabrication and in semiconductor fabrication.

Further preferable is a process for the preparation of a quartz glass body comprising pyrogenic silicon dioxide, comprising the following process steps:
i.) Providing a silicon dioxide granulate comprising the following process steps:
   I. Providing a pyrogenic silicon dioxide powder;
      wherein the pyrogenic silicon dioxide powder is present in the form of amorphous silicon dioxide particles, wherein the silicon dioxide powder has the following properties:
         a. a chlorine content of less than 200 ppm;
         b. an aluminium content of less than 200 ppb;
   II. Processing the silicon dioxide powder to obtain a silicon dioxide granulate I, wherein the silicon dioxide granulate I has a greater particle diameter than the silicon dioxide powder;
   III. Treating the silicon dioxide granulate I with a reactant to obtain a silicon dioxide granulate II;
ii.) Forming a glass melt from the silicon dioxide granulate II in an oven;
iii.) Forming a quartz glass body from at least as part of the glass melt, wherein the quartz glass body has the following properties:
   A] an OH content of less than 10 ppm;
   B] a chlorine content of less than 60 ppm;
   C] an aluminium content of less than 200 ppb; and
wherein the ppb and ppm are each based on the total weight of the quartz glass body.

### General

In the present description disclosed ranges also include the boundary values. A disclosure of the form “in the range from X to Y” in relation to a parameter A therefore means that A can take the values X, Y and values in between X and Y. Ranges bounded on one side of the form “up to Y” for a parameter A mean correspondingly the value Y and those less than Y.

### DETAILED DESCRIPTION OF THE INVENTION

A first aspect of the present invention is a process for the preparation of a quartz glass body comprising pyrogenic silicon dioxide, comprising the following process steps:
i.) Providing a silicon dioxide granulate comprising the following process steps:
   I. Providing a pyrogenic silicon dioxide powder;
   II. Processing the silicon dioxide powder to give a silicon dioxide granulate, wherein the silicon dioxide granulate has a larger particle diameter than the silicon dioxide powder;
ii.) Making a glass melt out of the silicon dioxide granulate in an oven
iii.) Making a quartz glass body out of at least part of the glass melt; wherein the quartz glass body has the following properties:
   A] an OH content of less than 10 ppm;
   B] a chlorine content of less than 60 ppm;
   C] an aluminium content of less than 200 ppb; and
wherein the ppb and ppm are each based on the total weight of the quartz glass body

### Step i.)

According to the invention, the provision of the silicon dioxide granulate comprises the following process steps:
I. Providing a pyrogenic silicon dioxide powder; and
II. Processing the silicon dioxide powder to obtain a silicon dioxide granulate, wherein the silicon dioxide granulate has a greater particle diameter than the silicon dioxide powder.

A powder means particles of a dry solid material with a primary particle size in the range from 1 to less than 100 nm.

The silicon dioxide granulate can be obtained by granulating silicon dioxide powder. A silicon dioxide granulate commonly has a BET surface area of 3 m²/g or more and a density of less than 1.5 g/cm³. Granulating means transforming powder particles into granules. During granulation, clusters of multiple silicon dioxide powder particles, i.e. larger agglomerates, form which are referred to as “silicon dioxide granules”. These are often also called “silicon dioxide granulate particles” or “granulate particles”. Collectively, the granules form a granulate, e.g. the silicon dioxide granules form a “silicon dioxide granulate”. The silicon dioxide granulate has a greater particle diameter than the silicon dioxide powder.

The granulation procedure, for transforming a powder into a granulate, will be described in more detail later.

Silicon dioxide grain in the present context means silicon dioxide particles which are obtainable by reduction in size of a silicon dioxide body, in particular of a quartz glass body. A silicon dioxide grain commonly has a density of more than 1.2 g/cm³, for example in a range from 1.2 to 2.2 g/cm³, and particularly preferably of about 2.2 g/cm³. Furthermore, the BET surface area of a silicon dioxide grain is preferably generally less than 1 m²/g, determined according to DIN ISO 9277:2014-01.

In principle, all silicon dioxide particles which are considered to be suitable by the skilled man can be selected.

Preferred are silicon dioxide granulate and silicon dioxide grain.

Particle diameter or particle size mean the diameter of a particle, given as the “area equivalent circular diameter x_{Ai}” according to the formula

$${x}_{Ai} = \sqrt{\frac{4 {A}_{i}}{π}} ,$$

wherein Ai stands for the surface area of the observed particle by means of image analysis. Suitable methods for the measurement are for example ISO 13322-1:2014 or ISO 13322-2:2009. Comparative disclosures such as “greater particle diameter” always means that the values being compared are measured with the same method.

### Silicon Dioxide Powder

In the context of the present invention, synthetic silicon dioxide powder, namely pyrogenically produced silicon dioxide powder, is used.

The silicon dioxide powder can be any silicon dioxide powder which has at least two particles. As preparation process, any process which the skilled man considers to be prevalent in the art and suitable can be used.

According to a preferred embodiment of the present invention, the silicon dioxide powder is produced as side product in the preparation of quartz glass, in particular in the preparation of so called “soot bodies”. Silicon dioxide from such a source is often also called “soot dust”.

A preferred source for the silicon dioxide powder are silicon dioxide particles which are obtained from the synthetic preparation of soot bodies by application of flame hydrolysis burners. In the preparation of a soot body, a rotating carrier tube with a cylinder jacket surface is moved back and forth along a row of burners. Flame hydrolysis burners can be fed with oxygen and hydrogen as burner gases as well as the raw materials for making silicon dioxide primary particles. The silicon dioxide primary particles preferably have a primary particle size of up to 100 nm. The silicon dioxide primary particles produced by flame hydrolysis aggregate or agglomerate to form silicon dioxide particles with particle sizes of about 9 μm (DIN ISO 13320:2009-1). In the silicon dioxide particles, the silicon dioxide primary particles are identifiable by their form by scanning electron microscopy and the primary particle size can be measured. A portion of the silicon dioxide particles are deposited on the cylinder jacket surface of the carrier tube which is rotating about its longitudinal axis. In this way, the soot body is built up layer by layer. Another portion of the silicon dioxide particles are not deposited on the cylinder jacket surface of the carrier tube, rather they accumulate as dust, e.g. in a filter system. This other portion of silicon dioxide particles make up the silicon dioxide powder, often also called “soot dust”. In general, the portion of the silicon dioxide particles which are deposited on the carrier tube is greater than the portion of silicon dioxide particles which accumulate as soot dust in the context of soot body preparation, based on the total weight of the silicon dioxide particles.

These days, soot dust is generally disposed of as waste in an onerous and costly manner, or used as filler material without adding value, e.g. in road construction, as additive in the dyes industry, as a raw material for the tiling industry and for the preparation of hexafluorosilicic acid, which is employed for restoration of construction foundations. In the case of the present invention, it is a suitable raw material and can be processed to obtain a high-quality product.

Silicon dioxide prepared by flame hydrolysis is normally called pyrogenic silicon dioxide. Pyrogenic silicon dioxide is normally available in the form of amorphous silicon dioxide primary particles or silicon dioxide particles.

According to a preferred embodiment, the silicon dioxide powder can be prepared by flame hydrolysis out of a gas mixture. In this case, silicon dioxide particles are also created in the flame hydrolysis and are taken away before agglomerates or aggregates form. Here, the silicon dioxide powder, previously referred to as soot dust, is the main product.

Suitable raw materials for creating the silicon dioxide powder are preferably siloxanes, silicon alkoxides and inorganic silicon compounds. Siloxanes means linear and cyclic polyalkylsiloxanes. Preferably, polyalkylsiloxanes have the general formula

SiₚOₚR₂ₚ,
wherein p is an integer of at least 2, preferably from 2 to 10, particularly preferably from 3 to 5, and R is an alkyl group with 1 to 8 C-atoms, preferably with 1 to 4 C-atoms, particularly preferably a methyl group.

Particularly preferred are siloxanes selected from the group consisting of hexamethyldisiloxane, hexamethylcyclotrisiloxane (D3), octamethylcyclotetrasiloxane (D4) and decamethylcyclopentasiloxane (D5) or a combination of two or more thereof. If the siloxane comprises D3, D4 and D5, then D4 is preferably the main component. The main component is preferably present in an amount of at least 70 wt.-%, preferably of at least 80 wt.-%, for example of at least 90 wt.-% or of at least 94 wt.-%, particularly preferably of at least 98 wt.-%, in each case based on the total amount of the silicon dioxide powder. Preferred silicon alkoxides are tetramethoxysilane and methyltrimethoxysilane. Preferred inorganic silicon compounds as raw material for silicon dioxide powder are silicon halides, silicates, silicon carbide and silicon nitride. Particularly preferred inorganic silicon compounds as raw material for silicon dioxide powder are silicon tetrachloride and trichlorosilane.

According to a preferred embodiment, the silicon dioxide powder can be prepared from a compound selected from the group consisting of siloxanes, silicon alkoxides and silicon halides.

Preferably, the silicon dioxide powder can be prepared from a compound selected from the group consisting of hexamethyldisiloxane, hexamethylcyclotrisiloxane, octamethylcyclotetrasiloxane, decamethylcyclopentasiloxane, tetramethoxysilane, methyltrimethoxysilane, silicon tetrachloride and trichlorosilane or a combination of two or more thereof, for example out of silicon tetrachloride and octamethylcyclotetrasiloxane, particularly preferably out of octamethylcyclotetrasiloxane.

For making silicon dioxide out of silicon tetrachloride by flame hydrolysis, various parameters are significant. A preferred composition of a suitable gas mixture comprises an oxygen content in the flame hydrolysis in a range from 25 to 40 vol.-%. The content of hydrogen can be in a range from 45 to 60 vol.-%. The content of silicon tetrachloride is preferably 5 to 30 vol.-%, all of the aforementioned vol.-% being based on the total volume of the gas flow. Further preferred is a combination of the above mentioned volume proportions for oxygen, hydrogen and SiCl₄. The flame in the flame hydrolysis preferably has a temperature in a range from 1500 to 2500° C., for example in a range from 1600 to 2400° C., particularly preferably in a range from 1700 to 2300° C. Preferably, the silicon dioxide primary particles created in the flame hydrolysis are taken away as silicon dioxide powder before agglomerates or aggregates form.

According to a preferred embodiment of the first aspect of the invention, the silicon dioxide powder has at least one, for example at least two or at least three or at least four, particularly preferably at least five of the following features:
a. a BET surface area in a range from 20 to 60 m²/g, for example from 25 to 55 m²/g, or from 30 to 50 m²/g, particularly preferably from 20 to 40 m²/g,
b. a bulk density 0.01 to 0.3 g/cm³, for example in the range from 0.02 to 0.2 g/cm³, preferably in the range from 0.03 to 0.15 g/cm³, further preferably in the range from 0.1 to 0.2 g/cm³ or in the range from 0.05 to 0.1 g/cm³, or in the range from 0.05 to 0.3 g/cm³.
c. a carbon content of less than 50 ppm, for example of less than 40 ppm or of less than 30 ppm, particularly preferably in a range from 1 ppb to 20 ppm;
d. a chlorine content of less than 200 ppm, for example of less than 150 ppm or of less than 100 ppm, particularly preferably in a range from 1 ppb to 80 ppm;
e. an aluminium content of less than 200 ppb, for example in the range from 1 to 100 ppb, particularly preferably in the range from 1 to 80 ppb;
f. a total content of metals different to aluminium of less than 5 ppm, for example of less than 2 ppm, particularly preferably in a range from 1 ppb to 1 ppm;
g. at least 70 wt.-% of the powder particles have a primary particle size in a range from 10 to less than 100 nm, for example in the range from 15 to less than 100 nm, particularly preferably in the range from 20 to less than 100 nm;
h. a tamped density in a range from 0.001 to 0.3 g/cm³, for example in the range from 0.002 to 0.2 g/cm³ or from 0.005 to 0.1 g/cm³, preferably in the range from 0.01 to 0.06 g/cm³, also preferably in the range from 0.1 to 0.2 g/cm³ or in the range from 0.5 to 0.2 g/cm³;
i. a residual moisture content of less than 5 wt.-%, for example in the range from 0.25 to 3 wt.-%, particularly preferably in the range from 0.5 to 2 wt.-%;
j. a particle size distribution D₁₀ in the range from 1 to 7 μm, for example in the range from 2 to 6 μm or in the range from 3 to 5 μm, particularly preferably in the range from 3.5 to 4.5 μm;
k. a particle size distribution D₅₀ in the range from 6 to 15 μm, for example in the range from 7 to 13 μm or in the range from 8 to 11 μm, particularly preferably in the range from 8.5 to 10.5 μm;
l. a particle size distribution D₉₀ in the range from 10 to 40 μm, for example in the range from 15 to 35 μm, particularly preferably in the range from 20 to 30 μm;
wherein the wt.-%, ppm and ppb are each based on the total weight of the silicon dioxide powder.

The silicon dioxide powder contains silicon dioxide. Preferably, the silicon dioxide powder contains a proportion of silicon dioxide of more than 95 wt.-%, for example more than 98 wt.-% or more than 99 wt.-%. or more than 99.9 wt.-%, in each case based on the total weight of the silicon dioxide powder. Particularly preferably, the silicon dioxide powder contains a proportion of silicon dioxide of more than 99.99 wt.-%, based on the total weight of the silicon dioxide powder.

Preferably, the silicon dioxide powder has a metal content of metals different from aluminium of less than 5 ppm, for example of less than 2 ppm, particularly preferably of less than 1 ppm, in each case based on the total weight of the silicon dioxide powder. Often however, the silicon dioxide powder has a content of metals different to aluminium of at least 1 ppb. Such metals are for example sodium, lithium, potassium, magnesium, calcium, strontium, germanium, copper, molybdenum, tungsten, titanium, iron and chromium. These can be present for example in elemental form, as an ion, or as part of a molecule or of an ion or of a complex.

Preferably, the silicon dioxide powder has a total content of further constituents of less than 30 ppm, for example of less than 20 ppm, particularly preferably of less than 15 ppm, the ppm in each case being based on the total weight of the silicon dioxide powder. Often however, the silicon dioxide powder has a content of further constituents of at least 1 ppb. Further constituents means all constituents of the silicon dioxide powder which do not belong to the following group: silicon dioxide, chlorine, aluminium, OH-groups.

In the present context, reference to a constituent, when the constituent is a chemical element, means that it can be present as element or as an ion or in a compound or a salt. For example the term “aluminium” includes in addition to metallic aluminium, also aluminium salts, aluminium oxides and aluminium metal complexes. For example, the term “chlorine” includes, in addition to elemental chlorine, chlorides such as sodium chloride and hydrogen chloride. Often, the further constituents are present in the same aggregate state as the material in which they are contained.

In the present context, in the case where a constituent is a chemical compound or a functional group, reference to the constituent means that the constituent can be present in the form disclosed, as a charged chemical compound or as derivative of the chemical compound. For example, reference to the chemical material ethanol includes, in addition to ethanol, also ethanolate, for example sodium ethanolate. Reference to “OH-group” also includes silanol, water and metal hydroxides. For example, reference to derivate in the context of acetic acid also includes acetic acid ester and acetic acid anhydride.

Preferably, at least 70% of the powder particles of the silicon dioxide powder, based on the number of powder particles, have a primary particle size of less than 100 nm, for example in the range from 10 to 100 nm or from 15 to 100 nm, and particularly preferably in the range from 20 to 100 nm. The primary particle size is measured by dynamic light scattering according to ISO 13320:2009-10.

Preferably at least 75% of the powder particles of the silicon dioxide powder, based on the number of powder particles, have a primary particle size of less than 100 nm, for example in the range from 10 to 100 nm or from 15 to 100 nm, and particularly preferably in the range from 20 to 100 nm.

Preferably, at least 80% of the powder particles of the silicon dioxide powder, based on the number of powder particles, have a primary particle size of less than 100 nm, for example in the range from 10 to 100 nm or from 15 to 100 nm, and particularly preferably in the range from 20 to 100 nm.

Preferably, at least 85% of the powder particles of the silicon dioxide powder, based on the number of powder particles, have a primary particle size of less than 100 nm, for example in the range from 10 to 100 nm or from 15 to 100 nm, and particularly preferably in the range from 20 to 100 nm.

Preferably, at least 90% of the powder particles of the silicon dioxide powder, based on the number of powder particles, have a primary particle size of less than 100 nm, for example in the range from 10 to 100 nm or from 15 to 100 nm, and particularly preferably in the range from 20 to 100 nm.

Preferably, at least 95% of the powder particles of the silicon dioxide powder, based on the number of powder particles, have a primary particle size of less than 100 nm, for example in the range from 10 to 100 nm or from 15 to 100 nm, and particularly preferably in the range from 20 to 100 nm.

Preferably, the silicon dioxide powder has a particle size D₁₀ in the range from 1 to 7 μm, for example in the range from 2 to 6 μm or in the range from 3 to 5 μm, particularly preferably in the range from 3.5 to 4.5 μm. Preferably, the silicon dioxide powder has a particle size D₅₀ in the range from 6 to 15 μm, for example in the range from 7 to 13 μm or in the range from 8 to 11 μm, particularly preferably in the range from 8.5 to 10.5 μm. Preferably, the silicon dioxide powder has a particle size D₉₀ in the range from 10 to 40 μm, for example in the range from 15 to 35 μm, particularly preferably in the range from 20 to 30 μm.

Preferably, the silicon dioxide powder has a specific surface area (BET-surface area) in a range from 20 to 60 m²/g, for example from 25 to 55 m²/g, or from 30 to 50 m²/g, particularly preferably from 20 to 40 m²/g. The BET surface area is determined according to the method of Brunauer, Emmet and Teller (BET) by means of DIN 66132 which is based on gas absorption at the surface to be measured.

Preferably, the silicon dioxide powder has a pH value of less than 7, for example in the range from 3 to 6.5 or from 3.5 to 6 or from 4 to 5.5, particularly preferably in the range from 4.5 to 5. The pH value can be determined by means of a single rod measuring electrode (4% silicon dioxide powder in water).

The silicon dioxide powder preferably has the feature combination a./b./c. or a./b./f. or a./b./g., further preferably the feature combination a./b./c./f. or a./b./c./g. or a./b./f./g., particularly preferably the feature combination a./b./c./f./g.

The silicon dioxide powder preferably has the feature combination a./b./c., wherein the BET-surface area is in a range from 20 to 40 m²/g, the bulk density is in a range from 0.05 to 0.3 g/mL and the carbon content is less than 40 ppm.

The silicon dioxide powder preferably has the feature combination a./b./f., wherein the BET-surface area is in a range from 20 to 40 m²/g, the bulk density is in a range from 0.05 to 0.3 g/mL and the total content of metals which are different to aluminium is in a range from 1 ppb to 1 ppm.

The silicon dioxide powder preferably has the feature combination a./b./g., wherein the BET-surface area is in a range from 20 to 40 m²/g, the bulk density is in a range from 0.05 to 0.3 g/mL and at least 70 wt. % of the powder particles have a primary particle size in a range from 20 to less than 100 nm.

The silicon dioxide powder preferably has the feature combination a./b./c./f., wherein the BET-surface area is in a range from 20 to 40 m²/g, the bulk density is in a range from 0.05 to 0.3 g/mL, the carbon content is less than 40 ppm and the total content of metals which are different to aluminium is in a range from 1 ppb to 1 ppm.

The silicon dioxide powder preferably has the feature combination a./b./c./g., wherein the BET-surface area is in a range from 20 to 40 m²/g, the bulk density is in a range from 0.05 to 0.3 g/mL, the carbon content is less than 40 ppm and at least 70 wt. % of the powder particles have a primary particle size in a range from 20 to less than 100 nm.

The silicon dioxide powder preferably has the feature combination a./b./f/g., wherein the BET-surface area is in a range from 20 to 40 m²/g, the bulk density is in a range from 0.05 to 0.3 g/mL, the total content of metals which are different to aluminium is in a range from 1 ppb to 1 ppm, and at least 70 wt. % of the powder particles have a primary particle size in a range from 20 to less than 100 nm.

The silicon dioxide powder preferably has the feature combination a./b./c./f/g., wherein the BET-surface area is in a range from 20 to 40 m²/g, the bulk density is in a range from 0.05 to 0.3 g/mL, the carbon content is less than 40 ppm, the total content of metals which are different to aluminium is in a range from 1 ppb to 1 ppm and at least 70 wt. % of the powder particles have a primary particle size in a range from 20 to less than 100 nm.

### Step II.

According to the invention, silicon dioxide powder is processed in step II to obtain a silicon dioxide granulate, wherein the silicon dioxide granulate has a greater particle diameter than the silicon dioxide powder. For this purpose, any processes known to the skilled man that lead to an increase in the particle diameter are suitable.

The silicon dioxide granulate has a particle diameter which is greater than the particle diameter of the silicon dioxide powder. Preferably, the particle diameter of the silicon dioxide granulate is in a range from 500 to 50,000 times as great as the particle diameter of the silicon dioxide powder, for example 1,000 to 10,000 times as great, particularly preferably 2,000 to 8,000 times as great.

Preferably, at least 90% of the silicon dioxide granulate provided in step i.) is made up of pyrogenically produced silicon dioxide powder, for example at least 95 wt.-% or at least 98 wt.-%, particularly preferably at least 99 wt. % or more, in each case based on the total weight of the silicon dioxide granulate.

According to a preferred embodiment of the first aspect of the invention, the silicon dioxide granulate employed has the following features:
A) a chlorine content of less than 500 ppm, preferably of less than 400 ppm, for example less than 300 ppm or of less than 200 ppm, particularly preferably of less than 100 ppm or in a range of 1 ppb to 500 ppm or of 1 ppb to 300 ppm particularly preferably of 1 ppb to 100 ppm;
B) an aluminium content of less than 200 ppb, for example of less than 150 ppb or of less than 100 ppb or of 1 to 150 ppb or of 1 to 100 ppb, particularly preferably in a range of 1 to 80 ppb;
C) a BET surface area in the range from 20 m²/g to 50 m²/g;
D) a pore volume in a range from 0.1 to 2.5 mL/g, for example in a range from 0.15 to 1.5 mL/g; particularly preferably in a range from 0.2 to 0.8 mL/g;
E) a bulk density in a range from 0.5 to 1.2 g/cm³, for example in a range from 0.6 to 1.1 g/cm³, particularly preferably in a range from 0.7 to 1.0 g/cm³;
F) a tamped density in a range from 0.7 to 1.2 g/cm³;
G) a mean particle size in a range from 50 to 500 μm;
H) a carbon content of less than 50 ppm;
I) an angle of repose in a range from 23 to 26°;
J) a particle size distribution D₁₀ in a range from 50 to 150 μm;
K) a particle size distribution D₅₀ in a range from 150 to 300 μm;
L) a particle size distribution D₉₀ in a range from 250 to 620 μm, wherein the ppm and ppb are each based on the total weight of the silicon dioxide granulate.

Preferably, the granules of the silicon dioxide granulate have a spherical morphology. Spherical morphology means a round or oval form of the particle. The granules of the silicon dioxide granulate preferably have a mean sphericity in a range from 0.7 to 1.3 SPHT3, for example a mean sphericity in a range from 0.8 to 1.2 SPHT3, particularly preferably a mean sphericity in a range from 0.85 to 1.1 SPHT3. The feature SPHT3 is described in the test methods.

Furthermore, the granules of the silicon dioxide granulate preferably have a mean symmetry in a range from 0.7 to 1.3 Symm3, for example a mean symmetry in a range from 0.8 to 1.2 Symm3, particularly preferably a mean symmetry in a range from 0.85 to 1.1 Symm3. The feature of the mean symmetry Symm3 is described in the test methods.

Preferably, the silicon dioxide granulate has a metal content of metals different to aluminium of less than 1000 ppb, for example of less than 500 ppb, particularly preferably of less than 100 ppb, in each case based on the total weight of the silicon dioxide granulate. Often however, the silicon dioxide granulate has a content of metals different to aluminium of at least 1 ppb. Often, the silicon dioxide granulate has a metal content of metals different to aluminium of less than 1 ppm, preferably in a range from 40 to 900 ppb, for example in a range from 50 to 700 ppb, particularly preferably in a range from 60 to 500 ppb, in each case based on the total weight of the silicon dioxide granulate. Such metals are for example sodium, lithium, potassium, magnesium, calcium, strontium, germanium, copper, molybdenum, titanium, iron and chromium. These can for example be present as an element, as an ion, or as part of a molecule or of an ion or of a complex.

The silicon dioxide granulate can comprise further constituents, for example in the form of molecules, ions or elements. Preferably, the silicon dioxide granulate comprises less than 500 ppm of further constituents, for example less than 300 ppm, particularly preferably less than 100 ppm, in each case based on the total weight of the silicon dioxide granulate. Often, at least 1 ppb of further constituents are comprised. The further constituents can in particular be selected from the group consisting of carbon, fluoride, iodide, bromide, phosphorus or a mixture of at least two thereof.

Preferably, the silicon dioxide granulate comprises less than 10 ppm carbon, for example less than 8 ppm or less than 5 ppm, particularly preferably less than 4 ppm, in each case based on the total weight of the silicon dioxide granulate. Often, at least 1 ppb of carbon is comprised in the silicon dioxide granulate.

Preferably, the silicon dioxide granulate comprises less than 100 ppm of further constituents, for example less than 80 ppm, particularly preferably less than 70 ppm, in each case based on the total weight of the silicon dioxide granulate. Often however, at least 1 ppb of the further constituents are comprised.

Preferably, step II. comprises the following steps:
II.1. Providing a liquid;
II.2. Mixing the silicon dioxide powder with the liquid to obtain a slurry;
II.3. Granulating, preferably spray drying, the slurry.

In the context of the present invention, a liquid means a material or a mixture of materials which is liquid at a pressure of 1013 hPa and a temperature of 20° C.

A “slurry” in the context of the present invention means a mixture of at least two materials, wherein the mixture, considered under the prevailing conditions, comprises at least one liquid and at least one solid.

Suitable liquids are all materials and mixtures of materials known to the skilled man and which appear suitable for the present application. Preferably, the liquid is selected from the group consisting of organic liquids and water.

Preferably, the solubility of the silicon dioxide powder in the liquid is less than 0.5 g/L, preferably less than 0.25 g/L, particularly preferably less than 0.1 g/L, the g/L each given as g silicon dioxide powder per litre liquid.

Preferred suitable liquids are polar solvents. These can be organic liquids or water. Preferably, the liquid is selected from the group consisting of water, methanol, ethanol, n-propanol, iso-propanol, n-butanol, tert-butanol and mixtures of a more than one thereof. Particularly preferably, the liquid is water. Particularly preferably, the liquid comprises distilled or de-ionized water.

Preferably, the silicon dioxide powder is processed to obtain a slurry. The silicon dioxide powder is virtually insoluble in the liquid at room temperature, but can be introduced into the liquid in high weight proportions to obtain the slurry.

The silicon dioxide powder and the liquid can be mixed in any manner. For example, the silicon dioxide powder can be added to the liquid, or the liquid can be added to the silicon dioxide powder. The mixture can be agitated during the addition or following the addition. Particularly preferably, the mixture is agitated during and following the addition. Examples for the agitation are shaking and stirring, or a combination of both. Preferably, the silicon dioxide powder can be added to the liquid under stirring. Furthermore, preferably, a portion of the silicon dioxide powder can be added to the liquid, wherein the mixture thus obtained is agitated, and the mixture is subsequently mixed with the remaining portion of the silicon dioxide powder. Likewise, a portion of the liquid can be added to the silicon dioxide powder, wherein the mixture thus obtained is agitated, and the mixture subsequently mixed with the remaining portion of the liquid.

By mixing the silicon dioxide powder and the liquid, a slurry is obtained. Preferably, the slurry is a suspension in which the silicon dioxide powder is distributed uniformly in the liquid. “Uniform” means that the density and the composition of the slurry at each position does not deviate from the average density and from the average composition by more than 10%, in each case based on the total amount of slurry. A uniform distribution of the silicon dioxide powder in the liquid can prepared, or obtained, or both, by an agitation as mentioned above.

Preferably, the slurry has a weight per litre in the range from 1000 to 2000 g/L, for example in the range from 1200 to 1900 g/L or from 1300 to 1800 g/L, particularly preferably in the range from 1400 to 1700 g/L. The weight per litre is measured by weighing a volume calibrated container.

According to a preferred embodiment, at least one, for example at least two or at least three or at least four, particularly preferably at least five of the following features applies to the slurry:
a.) the slurry is transported in contact with a plastic surface;
b.) the slurry is sheared;
c.) the slurry has a temperature of more than 0° C., preferably in a range from 5 to 35° C.;
d.) the slurry has a zeta potential at a pH value of 7 in a range from 0 to −100 mA, for example from −20 to −60 mA, particularly preferably from −30 to −45 mA;
e.) the slurry has a pH value in a range of 7 or more, for example of more than 7 or a pH value in the range from 7.5 to 13 or from 8 to 11, particularly preferably from 8.5 to 10;
f.) the slurry has an isoelectric point of less than 7, for example in a range from 1 to 5 or in a range from 2 to 4, particularly preferably in a range from 3 to 3.5;
g.) the slurry has a solids content of at least 40 wt.-%, for example in a range from 50 to 80 wt.-%, or in a range from 55 to 75 wt.-%, particularly preferably in a range from 60 to 70 wt.-%, in each case based on the total weight of the slurry;
h.) the slurry has a viscosity according to DIN 53019-1 (5 rpm, 30 wt.-%) in a range from 500 to 2000 mPas, for example in the range from 600 to 1700 mPas, particularly preferably in the range from 1000 to 1600 mPas;
i.) the slurry has a thixotropy according to DIN SPEC 91143-2 (30 wt.-% in water, 23° C., 5 rpm/50 rpm) in the range from 3 to 6, for example in the range from 3.5 to 5, particularly preferably in the range from 4.0 to 4.5;
j.) the silicon dioxide particles in the slurry have in a 4 wt.-% slurry a mean particle size in suspension according to DIN ISO 13320-1 in the range from 100 to 500 nm, for example in a range from 200 to 300 nm.

Preferably, the silicon dioxide particles in a 4 wt.-% aqueous slurry have a particle size D₁₀ in a range from 50 to 250 nm, particularly preferably in the range from 100 to 150 nm. Preferably, the silicon dioxide particles in a 4 wt.-% aqueous slurry have a particle size D₅₀ in a range from 100 to 400 nm, particularly preferably in the range from 200 to 250 nm. Preferably, the silicon dioxide particles in a 4 wt.-% aqueous slurry have a particle size D₉₀ in a range from 200 to 600 nm, particularly preferably in a range from 350 to 400 nm. The particle size is measured according to DIN ISO 13320-1.

“Isoelectric point” means the pH value at which the zeta potential takes the value 0. The zeta potential is measured according to ISO 13099-2:2012.

Preferably, the pH value of the slurry is set to a value in the range given above. Preferably, the pH value can be set by adding to the slurry materials such as NaOH or NH₃, for example as aqueous solution. During this process, the slurry is often agitated.

### Granulation

The silicon dioxide granulate is obtained from the silicon dioxide powder by granulation. Granulation means the transformation of powder particles into granules. During granulation, larger agglomerates which are referred to as “silicon dioxide granules” are formed by agglomeration of multiple silicon dioxide powder particles. These are often also called “silicon dioxide particles”, “silicon dioxide granulate particles” or “granulate particles”. Collectively, granules make up a granulate, e.g. the silicon dioxide granules make up a “silicon dioxide granulate”.

In the present case, any granulation process which is known to the skilled man and appears to him to be suitable for the granulation of silicon dioxide powder can in principle be selected. Granulation processes can be categorised as agglomeration granulation processes or press granulation processes, and further categorised as wet and dry granulation processes. Known methods are roll granulation in a granulation plate, spray granulation, centrifugal pulverisation, fluidised bed granulation, granulation processes employing a granulation mill, compactification, roll pressing, briquetting, scabbing or extruding.

### Spray Drying

According to a preferred embodiment of the first aspect of the invention, a silicon dioxide granulate is obtained by spray granulation of the slurry. Spray granulation is also known as spray drying.

Spray drying is preferably effected in a spray tower. For spray drying, the slurry is preferably put under pressure at a raised temperature. The pressurised slurry is then depressurised via a nozzle and thus sprayed into the spray tower. Subsequently, droplets form which instantly dry and first form dry minute particles (“nuclei”). The minute particles form, together with a gas flow applied to the particles, a fluidised bed. In this way, they are maintained in a floating state and can thus form a surface for drying further droplets.

The nozzle, through which the slurry is sprayed into the spray tower, preferably forms an inlet into the interior of the spray tower.

The nozzle preferably has a contact surface with the slurry during spraying. “Contact surface” means the region of the nozzle which comes into contact with the slurry during spraying. Often, at least part of the nozzle is formed as a tube through which the slurry is guided during spraying, so that the inner side of the hollow tube comes into contact with the slurry.

The contact surface preferably comprises a glass, a plastic or a combination thereof. Preferably, the contact surface comprises a glass, particularly preferably quartz glass. Preferably, the contact surface comprises a plastic. In principle, all plastics known to the skilled man, which are stable at the process temperatures and do not pass any foreign atoms to the slurry, are suitable. Preferred plastics are polyolefins, for example homo- or co-polymers comprising at least one olefin, particularly preferably homo- or co-polymers comprising polypropylene, polyethylene, polybutadiene or combinations of two or more thereof. Preferably, the contact surface is made of a glass, a plastic or a combination thereof, for example selected from the group consisting of quartz glass and polyolefins, particularly preferably selected from the group consisting of quartz glass and homo- or co-polymers comprising polypropylene, polyethylene, polybutadiene or combinations of two or more thereof. Preferably, the contact surface comprises no metals, in particular no tungsten, titanium, tantalum, chromium, cobalt, nickel, iron, vanadium, zirconium and manganese.

It is in principle possible for the contact surface and the further parts of the nozzle to be made of the same or from different materials. Preferably, the further parts of the nozzle comprise the same material as the contact surface. It is likewise possible for the further parts of the nozzle to comprise a material different to the contact surface. For example, the contact surface can be coated with a suitable material, for example with a glass or with a plastic.

Preferably, the nozzle is more than 70 wt.-%, based on the total weight of the nozzle, made out of an item selected from the group consisting of glass, plastic or a combination of glass and plastic, for example more than 75 wt.-% or more than 80 wt.-% or more than 85 wt.-% or more than 90 wt.-% or more than 95 wt.-%, particularly preferably more than 99 wt.-%.

Preferably, the nozzle comprises a nozzle plate. The nozzle plate is preferably made of glass, plastic or a combination of glass and plastic. Preferably, the nozzle plate is made of glass, particularly preferably quartz glass. Preferably, the nozzle plate is made of plastic. Preferred plastics are polyolefins, for example homo- or co-polymers comprising at least one olefin, particularly preferably homo- or co-polymers comprising polypropylene, polyethylene, polybutadiene or combinations of two or more thereof. Preferably, the nozzle plate comprises no metals, in particular no tungsten, titanium, tantalum, chromium, cobalt, nickel, iron, vanadium, zirconium and manganese.

Preferably, the nozzle comprises a screw twister. The screw twister is preferably made of glass, plastic or a combination of glass and plastic. Preferably, the screw twister is made of glass, particularly preferably quartz glass. Preferably, the screw twister is made of plastic. Preferred plastics are polyolefins, for example homo- or co-polymers comprising at least one olefin, particularly preferably homo- or co-polymers comprising polypropylene, polyethylene, polybutadiene or combinations of two or more thereof. Preferably, the screw twister comprises no metals, in particular no tungsten, titanium, tantalum, chromium, cobalt, nickel, iron, vanadium, zirconium and manganese.

Furthermore, the nozzle can comprise further constituents. Preferred further constituents are a nozzle body, particularly preferable is a nozzle body which surrounds the screw twister and the nozzle plate, a cross piece and a baffle. Preferably, the nozzle comprises one or more, particularly preferably all, of the further constituents. The further constituents can independently from each other be made of in principle any material which is known to the skilled man and which is suitable for this purpose, for example of a metal comprising material, of glass or of a plastic. Preferably, the nozzle body is made of glass, particularly preferably quartz glass. Preferably, the further constituents are made of plastic. Preferred plastics are polyolefins, for example homo- or co-polymers comprising at least one olefin, particularly preferably homo- or co-polymers comprising polypropylene, polyethylene, polybutadiene or combinations of two or more thereof. Preferably, the further constituents comprise no metals, in particular no tungsten, titanium, tantalum, chromium, cobalt, nickel, iron, vanadium, zirconium and manganese.

Preferably, the spray tower comprises a gas inlet and a gas outlet. Through the gas inlet, a gas can be introduced into the interior of the spray tower, and through the gas outlet it can be let out. It is also possible to introduce gas into the spray tower via the nozzle. Likewise, gas can be let out via the outlet of the spray tower. Furthermore, gas can preferably be introduced via the nozzle and a gas inlet of the spray tower, and let out via the outlet of the spray tower and a gas outlet of the spray tower.

Preferably, in the interior of the spray tower is present an atmosphere selected from air, an inert gas, at least two inert gases or a combination of air with at least one inert gas, preferably a combination of air with at least two inert gases. Inert gases are preferably selected from the list consisting of nitrogen, helium, neon, argon, krypton and xenon. For example, in the interior of the spray tower there is present air, nitrogen or argon, particularly preferably air.

Further preferably, the atmosphere present in the spray tower is part of a gas flow. The gas flow is preferably introduced into the spray tower via a gas inlet and let out via a gas outlet. It is also possible to introduce parts of the gas flow via the nozzle and to let out parts of the gas flow via a solids outlet. The gas flow can take on further constituents in the spray tower. These can come from the slurry during the spray drying and transfer to the gas flow.

Preferably, a dry gas flow is fed to the spray tower. A dry gas flow means a gas or a gas mixture which has a relative humidity at the temperature set in the spray tower below the condensation point. A relative air humidity of 100% corresponds to a water content of 17.5 g/m³ at 20° C. The gas is preferably pre-warmed to a temperature in a range from 150 to 450° C., for example from 200 to 420° C. or from 300 to 400° C., particularly preferably from 350 to 400° C.

The interior of the spray tower is preferably temperature-controllable. Preferably, the temperature in the interior of the spray tower has a value up to 550° C., for example 300 to 500° C., particularly preferably 350 to 450° C.

The gas flow preferably has a temperature at the gas inlet in a range from 150 to 450° C., for example from 200 to 420° C. or from 300 to 400° C., particularly preferably from 350 to 400° C.

The gas flow which is let out at the solids outlet, at the gas outlet or at both locations, preferably has a temperature of less than 170° C., for example from 50 to 150° C., particularly preferably from 100 to 130° C.

Furthermore, the difference between the temperature of the gas flow on introduction and of the gas flow on expulsion is preferably in a range from 100 to 330° C., for example from 150 to 300° C.

The thus obtained silicon dioxide granules are present as an agglomerate of individual particles of silicon dioxide powder. The individual particles of the silicon dioxide powder continue to be recognizable in the agglomerate. The mean particle size of the particles of the silicon dioxide powder is preferably in the range from 10 to 1000 nm, for example in the range from 20 to 500 nm or from 30 to 250 nm or from 35 to 200 nm or from 40 to 150 nm, or particularly preferably in the range from 50 to 100 nm. The mean particle size of these particles is measured according to DIN ISO 13320-1.

The spray drying can be carried out in the presence of auxiliaries. In principle, all materials can be employed as auxiliaries, which are known to the skilled man and which appear suitable for the present application. As auxiliary material for example, so-called binders can be considered. Examples of suitable binding materials are metal oxides such as calcium oxide, metal carbonates such as calcium carbonate and polysaccharides such as cellulose, cellulose ether, starch and starch derivatives.

Particularly preferably, the spray drying is carried out in the context of the present invention without auxiliaries.

Preferably, before, after or before and after the removal of the silicon dioxide granulate from the spray tower a portion thereof is separated off. For separating off, all processes which are known to the skilled man and which appear suitable can be considered. Preferably, the separating off is effected by a screening or a sieving.

Preferably, before removal from the spray tower of the silicon dioxide granulate which has been formed by spray drying, particles with a particle size of less than 50 μm, for example with a particle size of less than 70 μm particularly preferably with a particle size of less than 90 μm are separated off by screening. The screening is effected preferably using a cyclone arrangement, which is preferably arranged in the lower region of the spray tower, particularly preferably above the outlet of the spray tower.

Preferably, after removal of the silicon dioxide granulate from the spray tower, particles with a particle size of greater than 1000 μm, for example with a particle size of greater than 700 μm, particularly preferably with a particle size of greater than 500 μm are separated off by sieving. The sieving of the particles can in principle be effected by all processes known to the skilled man and which are suitable for this purpose. Preferably, the sieving is effected using a vibrating chute.

According to a preferred embodiment, the spray drying of the slurry through a nozzle into a spray tower is characterised by at least one, for example two or three, particularly preferably all of the following features:
a] spray granulation in a spray tower;
b] the presence of a pressure of the slurry at the nozzle of not more than 40 bar, for example in a range from 1.3 to 20 bar, from 1.5 to 18 bar or from 2 to 15 bar or from 4 to 13 bar, or particularly preferably in the range from 5 to 12 bar, wherein the pressure is given in absolute terms (relative to p=0 hPa);
c] a temperature of the droplets upon entering into the spray tower in a range from 10 to 50° C., preferably in a range from 15 to 30° C., particularly preferably in a range from 18 to 25° C.
d] a temperature at the side of the nozzle directed towards the spray tower in a range from 100 to 450° C., for example in a range from 250 to 440° C., particularly preferably from 350 to 430° C.;
e] A throughput of slurry through the nozzle in a range from 0.05 to 1 m³/h, for example in a range from 0.1 to 0.7 m³/h or from 0.2 to 0.5 m³/h, particularly preferably in a range from 0.25 to 0.4 m³/h;
f] A solids content of the slurry of at least 40 wt.-%, for example in a range from 50 to 80 wt.-%, or in a range from 55 to 75 wt.-%, particularly preferably in a range from 60 to 70 wt.-%, in each case based on the total weight of the slurry;
g] A gas inflow into the spray tower in a range from 10 to 100 kg/min, for example in a range from 20 to 80 kg/min or from 30 to 70 kg/min, particularly preferably in a range from 40 to 60 kg/min;
h] A temperature of the gas flow upon entering into the spray tower in a range from 100 to 450° C., for example in a range from 250 to 440° C., particularly preferably from 350 to 430° C.;
i] A temperature of the gas flow at the exit out of the spray tower of less than 170° C.;
j] The gas is selected from the group consisting of air, nitrogen and helium, or a combination of two or more thereof; preferably air;
k] a residual moisture content of the granulate on removal out of the spray tower of less than 5 wt.-%, for example of less than 3 wt.-% or of less than 1 wt.-% or in a range from 0.01 to 0.5 wt.-%, particularly preferably in a range from 0.1 to 0.3 wt.-%, in each case based on the total weight of the silicon dioxide granulate created in the spray drying;
l] at least 50 wt.-% of the spray granulate, based on the total weight of the silicon dioxide granulate created in the spray drying, completes a flight time in a range from 1 to 100 s, for example of a period from 10 to 80 s, particularly preferably over a period from 25 to 70 s;
m] at least 50 wt.-% of the spray granulate, based on the total weight of the silicon dioxide granulate created in the spray drying, covers a flight path of more than 20 m, for example of more than 30 or of more than 50 or of more than 70 or of more than 100 or of more than 150 or of more than 200 or in a range from 20 to 200 m or from 10 to 150 or from 20 to 100, particularly preferably a range from 30 to 80 m.
n] the spray tower has a cylindrical geometry;
o] a height of the spray tower of more than 10 m, for example of more than 15 m or of more than 20 m or of more than 25 m or of more than 30 m or in a range from 10 to 25 m, particularly preferably in a range from 15 to 20 m;
p] screening out of particles with a size of less than 90 μm before the removal of the granulate from the spray tower;
q] sieving out of particles with a size of more than 500 μm after the removal of the granulate from the spray tower, preferably in a vibrating chute;
r] The exit of the droplets of the slurry out of the nozzle occurs at an angle of 30 to 60 degrees from vertical, particularly preferably at an angle of 45 degree from vertical.

Vertical means the direction of the gravitational force vector.

The flight path means the path covered by a droplet of slurry from exiting out of the nozzle in the gas chamber of the spray tower to form a granule up to completion of the action of flying and falling. The action of flying and falling frequently ends by the granule impacting with the floor of the spray tower impacting or the granule impacting with other granules already lying on the floor of the spray tower, whichever occurs first.

The flight time is the period required by a granule to cover the flight path in the spray tower. Preferably, die granules have a helical flight path in the spray tower.

Preferably, at least 60 wt.-% of the spray granulate, based on the total weight of the silicon dioxide granulate created in the spray drying, cover a mean flight path of more than 20 m, for example of more than 30 or of more than 50 or of more than 70 or of more than 100 or of more than 150 or of more than 200 or in a range from 20 to 200 m or from 10 to 150 or from 20 to 100, particularly preferably a range from 30 to 80 m.

Preferably, at least 70 wt.-% of the spray granulate, based on the total weight of the silicon dioxide granulate created in the spray drying, cover a mean flight path of more than 20 m, for example of more than 30 or of more than 50 or of more than 70 or of more than 100 or of more than 150 or of more than 200 or in a range from 20 to 200 m or from 10 to 150 or from 20 to 100, particularly preferably a range from 30 to 80 m.

Preferably, at least 80 wt.-% of the spray granulate, based on the total weight of the silicon dioxide granulate created in the spray drying, cover a mean flight path of more than 20 m, for example of more than 30 or of more than 50 or of more than 70 or of more than 100 or of more than 150 or of more than 200 or in a range from 20 to 200 m or from 10 to 150 or from 20 to 100, particularly preferably a range from 30 to 80 m.

Preferably, at least 90 wt.-% of the spray granulate, based on the total weight of the silicon dioxide granulate created in the spray drying, cover a mean flight path of more than 20 m, for example of more than 30 or of more than 50 or of more than 70 or of more than 100 or of more than 150 or of more than 200 or in a range from 20 to 200 m or from 10 to 150 or from 20 to 100, particularly preferably a range from 30 to 80 m.

### Roll Granulation

According to a preferred embodiment of the first aspect of the invention of the invention, a silicon dioxide granulate is obtained by roll granulation of the slurry.

The roll granulation is carried out by stirring the slurry in the presence of a gas at raised temperature. Preferably, the roll granulation is effected in a stirring vessel fitted with a stirring tool. Preferably, the stirring vessel rotates in the opposite sense to the stirring tool. Preferably, the stirring vessel additionally comprises an inlet through which the silicon dioxide powder can be introduced into the stirring vessel, an outlet through which the silicon dioxide granulate can be removed, a gas inlet and a gas outlet.

For stirring the slurry, preferably a pin-type stirring tool is used. A pin-type stirring tool means a stirring tool fitted with multiple elongate pins having their longitudinal axis coaxial with the rotational axis of the stirring tool. The trajectory of the pins preferably traces coaxial circles around the axis of rotation.

Preferably, the slurry is set to a pH value of less than 7, for example to a pH value in the range from 2 to 6.5, particularly preferably to a pH value in a range from 4 to 6. For setting the pH value, an inorganic acid is preferably used, for example an acid selected from the group consisting of hydrochloric acid, sulphuric acid, nitric acid and phosphoric acid, particularly preferably hydrochloric acid.

Preferably, in the stirring vessel is present an atmosphere selected from air, an inert gas, at least two inert gases or a combination of air with at least one inert gas, preferably two inert gases. Inert gases are preferably selected from the list consisting of nitrogen, helium, neon, argon, krypton and xenon. Fore example, air, nitrogen or argon is present in the stirring vessel, particularly preferably air.

Furthermore, preferably, the atmosphere present in the stirring vessel is part of a gas flow. The gas flow is preferably introduced into the stirring vessel via the gas inlet and let out via the gas outlet. The gas flow can take on further constituents in the stirring vessel. These can originate from the slurry in the roll granulation and transfer into the gas flow.

Preferably, a dry gas flow is introduced to the stirring vessel. A dry gas flow means a gas or a gas mixture which has a relative humidity at the temperature set in the stirring vessel under the condensation point. The gas is preferably pre-warmed to a temperature in a range from 50 to 300° C., for example from 80 to 250° C., particularly preferably from 100 to 200° C.

Preferably, per 1 kg of the employed slurry, 10 to 150 m³ gas per hour is introduced into the stirring vessel, for example 20 to 100 m³ gas per hour, particularly preferably 30 to 70 m³ gas per hour.

During the mixing, the slurry is dried by the gas flow to form silicon dioxide granules. The granulate which is formed is removed from the stirring vessel.

Preferably, the removed granulate is dried further. Preferably, the drying is effected continuously, for example in a rotary kiln. Preferred temperatures for the drying are in a range from 80 to 250° C., for example in a range from 100 to 200° C., particularly preferably in a range from 120 to 180° C.

In the context of the present invention, continuous in respect of a process means that it can be operated continuously. That means that the introduction and removal of materials involved in the process can be effected on an ongoing basis whilst the process is being run. It is not necessary to interrupt the process for this.

Continuous as an attribute of an object, e.g. in relation to a “continuous oven”, means that this object is configured in such a way that a process carried out therein, or a process step carried out therein, can be carried out continuously.

The granulate obtained from the roll granulation can be sieved. The sieving can occur before or after the drying. Preferably it is sieved before drying. Preferably, granules with a particle size of less than 50 μm, for example with a particle size of less than 80 μm, particularly preferably with a particle size of less than 100 μm, are sieved out. Furthermore, preferably, granules with a particle size of greater than 900 μm, for example with a particle size of greater than 700 μm, particularly preferably with a particle size of greater than 500 μm, are sieved out. The sieving out of larger particles can in principle be carried out by any process known to the skilled man and which is suitable for this purpose. Preferably, the sieving out of larger particles is carried out by means of a vibrating chute.

According to a preferred embodiment, the roll granulation is characterised by at least one, for example two or three, particularly preferably all of the following features:
[a] The granulation is carried out in a rotating stirring vessel;
[b] The granulation is carried out in a gas flow of 10 to 150 kg gas per hour and per 1 kg slurry;
[c] The gas temperature on introduction is 40 to 200° C.;
[d] Granules with a particle size of less than 100 μm and of more than 500 μm are sieved out;
[e] The granules formed have a residual moisture content of 15 to 30 wt.-%;
[f] The granules formed are dried at 80 to 250° C., preferably in a continuous drying tube, particularly preferably to a residual moisture content of less than 1 wt.-%.

Preferably, the silicon dioxide granulate obtained by granulating, preferably by spray- or roll-granulating, also referred to as silicon dioxide granulate I, is treated before it is processed to obtain quartz glass bodies. This pre-treatment can fulfil various purposes which either facilitate the processing to obtain quartz glass bodies or influence the properties of the resulting quartz glass bodies. For example, the silicon dioxide granulate I can be compactified, purified, surface-modified or dried.

Preferably, the silicon dioxide granulate I can by subjected to a thermal, mechanical or chemical treatment or a combination of two or more treatments, wherein a silicon dioxide granulate II is obtained.

### Chemical

According to a preferred embodiment of the first aspect of the invention, the silicon dioxide granulate I has a carbon content w_{C(1)}. The carbon content w_{C(1)} is preferably less than 50 ppm, for example less than 40 ppm or less than 30 ppm, particularly preferably in a range from 1 ppb to 20 ppm, each based on the total weight of the silicon dioxide granulate I.

According to a preferred embodiment of the first aspect of the invention, the silicon dioxide granulate I comprises at least two particles. Preferably, the at least two particles can carry out a motion relative to each other. As means for bringing about the relative motion, in principle all means known to the skilled man and which appear to him to be suitable can be considered. Particular preferred is a mixing. A mixing can in principle be carried out in any manner. Preferably, a feed-oven is selected for this. Accordingly, the at least two particles can preferably perform a motion relative to each other by being agitated in a feed oven, for example in a rotary kiln.

Feed ovens mean ovens for which loading and unloading of the oven, so-called charging, is carried out continuously. Examples of feed-ovens are rotary kilns, roll-over type furnaces, belt conveyor ovens, conveyor ovens, continuous pusher-type furnaces. Preferably, for treatment of the silicon dioxide granulate I, rotary kilns are used.

According to a preferred embodiment of the first aspect of the invention, the silicon dioxide granulate I is treated with a reactant to obtain a silicon dioxide granulate II. The treatment is carried out in order to change the concentration of certain materials in the silicon dioxide granulate. The silicon dioxide granulate I can have impurities or certain functionalities, the content of which should be reduced, such as for example: OH groups, carbon containing compounds, transition metals, alkali metals and alkali earth metals. The impurities and functionalities can originate from the starting materials or can be introduced in the course of the process. The treatment of the silicon dioxide granulate I can serve various purposes. For example, employing treated silicon dioxide granulate I, i.e. silicon dioxide granulate II, can simplify the processing of the silicon dioxide granulate to obtain quartz glass bodies. Furthermore, this selection can be employed to tune the properties of the resulting quartz glass body. For example, the silicon dioxide granulate I can be purified or surface modified. The treatment of the silicon dioxide granulate I can be employed for improving the properties of the resulting quartz glass body.

Preferably, a gas or a combination of multiple gases is suitable as reactant. This is also referred to as a gas mixture. In principle, all gases known to the skilled man can be employed, which are known for the specified treatment and which appear to be suitable. Preferably, a gas selected from the group consisting of HCl, Cl₂, F₂, O₂, O₃, H₂, C₂F₄, C₂F₆, HClO₄, air, inert gas, e.g. N₂, He, Ne, Ar, Kr, or combinations of two or more thereof is employed.

Preferably, the treatment is carried out in the presence of a gas or a combination of two or more gases. Preferably, the treatment is carried out in a gas counter flow or a gas co-flow.

Preferably, the reactant is selected from the group consisting of HCl, Cl₂, F₂, O₂, O₃ or combinations of two or more thereof. Preferably, mixtures of two or more of the above-mentioned gases are used for the treatment of silicon dioxide granulate I. Through the presence of F, Cl or both, metals which are contained in silicon dioxide granulates I as impurities, such as for example transition metals, alkali metals and alkali earth metals, can be removed. In this connection, the above mentioned metals can be converted along with constituents of the gas mixture under the process conditions to obtain gaseous compounds which are subsequently drawn out and thus are no longer present in the granulate. Furthermore, preferably, the OH content in the silicon dioxide granulate I can be decreased by the treatment of the silicon dioxide granulate I with these gases.

Preferably, a gas mixture of HCl and Cl₂ is employed as reactant. Preferably, the gas mixture has an HCl content in a range from 1 to 30 vol.-%, for example in a range from 2 to 15 vol.-%, particularly preferably in a range from 3 to 10 vol.-%. Likewise, the gas mixture preferably has a Cl₂ content in a range from 20 to 70 vol.-%, for example in a range from 25 to 65 vol.-%, particularly preferably in a range from 30 to 60 vol.-%. The remainder up to 100 vol.-% can be made up of one or more inert gases, e.g. N₂, He, Ne, Ar, Kr, or of air. Preferably, the proportion of inert gas in reactants is in a range from 0 to less than 50 vol.-%, for example in a range from 1 to 40 vol. % or from 5 to 30 vol.-%, particularly preferably in a range from 10 to 20 vol.-%, in each case based on the total volume of the reactant.

O₂, C₂F₂, or mixtures thereof with Cl₂ are preferably used for purifying silicon dioxide granulate I which has been prepared from a siloxane or from a mixture of multiple siloxanes.

The reactant in the form of a gas or of a gas mixture is preferably contacted with the silicon dioxide granulate as a gas flow or as part of a gas flow with a throughput in a range from 50 to 2000 L/h, for example in a range from 100 to 1000 L/h, particularly preferably in a range from 200 to 500 L/h. A preferred embodiment of the contacting is a contact of the gas flow and silicon dioxide granulate in a feed oven, for example in a rotary kiln. Another preferred embodiment of the contacting is a fluidised bed process.

Through treatment of the silicon dioxide granulate I with the reactant, a silicon dioxide granulate II with a carbon content w_{C(2)} is obtained. The carbon content w_{C(2)} of the silicon dioxide granulate II is less than the carbon content w_{C(1)} of the silicon dioxide granulate I, based on the total weight of the respective silicon dioxide granulate. Preferably, w_{C(2)} is 0.5 to 99%, for example 20 to 80% or 50 to 95%, particularly preferably 60 to 99% less than w_{C(1)}.

### Thermal

Preferably, the silicon dioxide granulate I is additionally subjected to a thermal or mechanical treatment or to a combination of these treatments. One or more of these additional treatments can be carried out before or during the treatment with the reactant. Alternatively, or additionally, the additional treatment can also be carried out on the silicon dioxide granulate II. In what follows, the term “silicon dioxide granulate” comprises the alternatives “silicon dioxide granulate I” and “silicon dioxide granulate II”. It is equally possible to carry out the treatments described in the following to the “silicon dioxide granulate I”, or to the treated silicon dioxide granulate I, the “silicon dioxide granulate II”.

The treatment of the silicon dioxide granulate can serve various purposes. For example, this treatment facilitates the processing of the silicon dioxide granulate to obtain quartz glass bodies. The treatment can also influence the properties of the resulting glass body. For example, the silicon dioxide granulate can be compactified, purified, surface modified or dried. In this connection, the specific surface area (BET) can decrease. Likewise, the bulk density and the mean particle size can increase due to agglomerations of silicon dioxide particles. The thermal treatment can be carried out dynamically or statically.

For the dynamic thermal treatment, all ovens in which the silicon dioxide granulate can be thermally treated whilst being agitated are in principle suitable. For the dynamic thermal treatment, preferably feed ovens are used.

A preferred mean holding time of the silicon dioxide granulate in the dynamic thermal treatment is quantity dependent. Preferably, the mean holding time of the silicon dioxide granulate in the dynamic thermal treatment is in the range from 10 to 180 min, for example in the range from 20 to 120 min or from 30 to 90 min. Particularly preferably, the mean holding time of the silicon dioxide granulate in the dynamic thermal treatment is in the range from 30 to 90 min.

In the case of a continuous process, a defined portion of the flow of silicon dioxide granulate is used as a sample load for the measurement of the holding time, e.g. a gram, a kilogram or a tonne. The start and end of the holding time are determined by the introduction into and exiting from the continuous oven operation.

Preferably, the throughput of the silicon dioxide granulate in a continuous process for dynamic thermal treatment is in the range from 1 to 50 kg/h, for example in the range from 5 to 40 kg/h or from 8 to 30 kg/h. Particularly preferably, the throughput is in the range from 10 to 20 kg/h.

In the case of a discontinuous process for dynamic thermal treatment, the treatment time is given as the period of time between the loading and subsequent unloading of the oven.

In the case of a discontinuous process for dynamic thermal treatment, the throughput is in a range from 1 to 50 kg/h, for example in the range from 5 to 40 kg/h or from 8 to 30 kg/h. Particularly preferably, the throughput is in the range from 10 to 20 kg/h. The throughput can be achieved using a sample load of a determined amount which is treated for an hour. According to another embodiment, the throughput can be achieved through a number of loads per hour, wherein the weight of a single load corresponds to the throughput per hour divided by the number of loads. In this event, time of treatment corresponds to the fraction of an hour which is given by 60 minutes divided by the number of loads per hour.

Preferably, the dynamic thermal treatment of the silicon dioxide granulate is carried out at an oven temperature of at least 500° C., for example in the range from 510 to 1700° C. or from 550 to 1500° C. or from 580 to 1300° C., particularly preferably in the range from 600 to 1200° C.

Normally, the oven has the indicated temperature in the oven chamber. Preferably, this temperature deviates from the indicated temperature by less than 10% downwards or upwards, based on the entire treatment period and the entire length of the oven as well as at every point in time in the treatment as well as at every position in the oven.

Alternatively, in particular the continuous process of a dynamic thermal treatment of the silicon dioxide granulate can by carried out at differing oven temperatures. For example, the oven can have a constant temperature over the treatment period, wherein the temperature varies in section over the length of the oven. Such sections can be of the same length or of different lengths. Preferably, in this case, the temperature increases from the entrance of the oven to the exit of the oven. Preferably, the temperature at the entrance is at least 100° C. lower than at the exit, for example 150° C. lower or 200° C. lower or 300° C. lower or 400° C. lower. Furthermore, preferably, the temperature at the entrance is preferably at least 500° C., for example in the range from 510 to 1700° C. or from 550 to 1500° C. or from 580 to 1300° C., particularly preferably in the range from 600 to 1200° C. Furthermore, preferably, the temperature at the entrance is preferably at least 300° C., for example from 400 to 1000° C. or from 450 to 900° C. or from 500 to 800° C. or from 550 to 750° C., particularly preferably from 600 to 700° C. Furthermore, each of the temperature ranges given at the oven entrance can be combined with each of the temperature ranges given at the oven exit. Preferred combinations of oven entrance temperature ranges and oven exit temperature ranges are:

| Oven entrance temperature range | Oven exit temperature range |
|---|---|
| [° C.] | [° C.] |
| 400-1000 | 510-1300 |
| 450-900 | 550-1260 |
| 480-850 | 580-1200 |
| 500-800 | 600-1100 |
| 530-750 | 630-1050 |

For the static thermal treatment of the silicon dioxide granulate crucibles arranged in an oven are preferably used. Suitable as crucibles are sinter crucibles or metal sheet crucibles. Preferred are rolled metal sheet crucibles made out of multiple sheets which are riveted together. Examples of crucible materials are refractory metals, in particular tungsten, molybdenum and tantalum. The crucible can furthermore be made of graphite or in the case of the crucibles of refractory metals can be lined with graphite foil. Furthermore, preferably, the crucibles can be made of silicon dioxide. Particularly preferably, silicon dioxide crucibles are employed.

The mean holding time of the silicon dioxide granulate in the static thermal treatment is quantity dependent. Preferably, the mean holding time of the silicon dioxide granulate in the static thermal treatment for a 20 kg amount of silicon dioxide granulate I is in the range from 10 to 180 min, for example in the range from 20 to 120 min, particularly preferably in the range from 30 to 90 min.

Preferably, the static thermal treatment of the silicon dioxide granulate is carried out at an oven temperature of at least 800° C., for example in the range from 900 to 1700° C. or from 950 to 1600° C. or from 1000 to 1500° C. or from 1050 to 1400° C., particularly preferably in the range from 1100 to 1300° C.

Preferably, the static thermal treatment of the silicon dioxide granulate I is carried out at constant oven temperature. The static thermal treatment can also be carried out at a varying oven temperature. Preferably, in this case, the temperature increases during the treatment, wherein the temperature at the start of the treatment is at least 50° C. lower than at the end, for example 70° C. lower or 80° C. lower or 100° C. lower or 110° C. lower, and wherein the temperature at the end is preferably at least 800° C., for example in the range from 900 to 1700° C. or from 950 to 1600° C. or from 1000 to 1500° C. or from 1050 to 1400° C., particularly preferably in the range from 1100 to 1300° C.

### Mechanical

According to a further preferred embodiment, the silicon dioxide granulate I can be mechanically treated. The mechanical treatment can be carried out for increasing the bulk density. The mechanical treatment can be combined with the above mentioned thermal treatment. A mechanical treatment can avoid the agglomerates in the silicon dioxide granulate and therefore the mean particle size of the individual, treated silicon dioxide granules in the silicon dioxide granulate becoming too large. An enlargement of the agglomerates can hinder the further processing or have disadvantageous impacts on the properties of the quartz glass bodies prepared by the inventive process, or a combination of both effects. A mechanical treatment of the silicon dioxide granulate also promotes a uniform contact of the surfaces of the individual silicon dioxide granules with the gas or gases. This is in particular achieved by concurrent mechanical and chemical treatment with one or more gases. In this way, the effect of the chemical treatment can be improved.

The mechanical treatment of the silicon dioxide granulate can be carried out by moving two or more silicon dioxide granules relative to each other, for example by rotating the tube of a rotary kiln.

Preferably, the silicon dioxide granulate I is treated chemically, thermally and mechanically. Preferably, a simultaneous chemical, thermal and mechanical treatment of the silicon dioxide granulate I is carried out.

In the chemical treatment, the content of impurities in the silicon dioxide granulate I is reduced. For this, the silicon dioxide granulate I can be treated in a rotary kiln at raised temperature and under a chlorine and oxygen containing atmosphere. Water present in the silicon dioxide granulate I evaporates, organic materials react to form CO and CO₂. Metal impurities can be converted to volatile chlorine containing compounds.

Preferably, the silicon dioxide granulate I is treated in a chlorine and oxygen containing atmosphere in a rotary kiln at a temperature of at least 500° C., preferably in a temperature range from 550 to 1300° C. or from 600 to 1260° C. or from 650 to 1200° C. or from 700 to 1000° C., particularly preferably in a temperature range from 700 to 900° C. The chlorine containing atmosphere contains for example HCl or Cl₂ or a combination of both. This treatment causes a reduction of the carbon content.

Furthermore, preferably alkali and iron impurities are reduced. Preferably, a reduction of the number of OH groups is achieved. At temperatures under 700° C., treatment periods can be long, at temperatures above 1100° C. there is a risk that pores of the granulate close, trapping chlorine or gaseous chlorine compounds.

Preferably, it is also possible to carry out sequentially multiple chemical treatment steps, each concurrent with thermal and mechanical treatment. For example, the silicon dioxide granulate I can first be treated in a chlorine containing atmosphere and subsequently in an oxygen containing atmosphere. The low concentrations of carbon, hydroxyl groups and chlorine resulting therefrom facilitate the melting down of the silicon dioxide granulate II.

According to a further preferred embodiment, step II.2) is characterised by at least one, for example by at least two or at least three, particularly preferably by a combination of all of the following features:
N1) The reactant comprises HCl, Cl₂ or a combination therefrom;
N2) The treatment is carried out in a rotary kiln;
N3) The treatment is carried out at a temperature in a range from 600 to 900° C.;
N4) The reactant forms a counter flow;
N5) The reactant has a gas flow in a range from 50 to 2000 L/h, preferably 100 to 1000 L/h, particularly preferably 200 to 500 L/h;
N6) The reactant has a volume proportion of inert gas in a range from 0 to less than 50 vol.-%.

Preferably, the silicon dioxide granulate I has a particle diameter which is greater than the particle diameter of the silicon dioxide powder. Preferably, the particle diameter of the silicon dioxide granulate I is up to 300 times as great as the particle diameter of the silicon dioxide powder, for example up to 250 times as great or up to 200 times as great or up to 150 times as great or up to 100 times as great or up to 50 times as great or up to 20 times as great or up to 10 times as great, particularly preferably 2 to 5 times as great.

The silicon dioxide granulate obtained in this way is also called silicon dioxide granulate II. Particularly preferably, the silicon dioxide granulate II is obtained from the silicon dioxide granulate I in a rotary kiln by means of a combination of thermal, mechanical and chemical treatment.

The silicon dioxide granulate provided in step i.) is preferably selected from the group consisting of silicon dioxide granulate I, silicon dioxide granulate II and a combination therefrom.

“Silicon dioxide granulate I” means a granulate of silicon dioxide which is produced by granulation of silicon dioxide powder which was obtained through pyrolysis of silicon compounds in a fuel gas flame. Preferred fuel gases are oxyhydrogen gas, natural gas or methane gas, particularly preferable is oxyhydrogen gas.

“Silicon dioxide granulate II” means a granulate of silicon dioxide which is produced by post treatment of the silicon dioxide granulate I. Possible post treatments are chemical, thermal and/or mechanical treatments. This is described at length in the context of the description of the provision of the silicon dioxide granulate (process step II. of the first aspect of the invention).

Particularly preferably, the silicon dioxide granulate provided in step i.) is the silicon dioxide granulate I. The silicon dioxide granulate I has the following features:
[A] a BET surface area in the range from 20 to 50 m²/g, for example in a range from 20 to 40 m²/g; particularly preferably in a range from 25 to 35 m²/g; wherein the micro pore portion preferably accounts for a BET surface area in a range from 4 to 5 m²/g; for example in a range from 4.1 to 4.9 m²/g; particularly preferably in a range from 4.2 to 4.8 m²/g; and
[B] a mean particle size in a range from 180 to 300 μm.

Preferably, the silicon dioxide granulate I is characterised by at least one, for example by at least two or at least three or at least four, particularly preferably by at least five of the following features:
[C] a bulk density in a range from 0.5 to 1.2 g/cm³, for example in a range from 0.6 to 1.1 g/cm³, particularly preferably in a range from 0.7 to 1.0 g/cm³;
[D] a carbon content of less than 50 ppm, for example less than 40 ppm or less than 30 ppm or less than 20 ppm or less than 10 ppm, particularly preferably in a range from 1 ppb to 5 ppm;
[E] an aluminium content of less than 200 ppb, preferably of less than 100 ppb, for example of less than 50 ppb or from 1 to 200 ppb or from 15 to 100 ppb, particularly preferably in a range from 1 to 50 ppb.
[F] a tamped density in a range from 0.5 to 1.2 g/cm³, for example in a range from 0.6 to 1.1 g/cm³, particularly preferably in a range from 0.75 to 1.0 g/cm³;
[G] a pore volume in a range from 0.1 to 1.5 mL/g, for example in a range from 0.15 to 1.1 mL/g; particularly preferably in a range from 0.2 to 0.8 mL/g,
[H] a chlorine content of less than 200 ppm, preferably of less than 150 ppm, for example less than 100 ppm, or of less than 50 ppm, or of less than 1 ppm, or of less than 500 ppb, or of less than 200 ppb, or in a range from 1 ppb to less than 200 ppm, or from 1 ppb to 100 ppm, or from 1 ppb to 1 ppm, or from 10 ppb to 500 ppb, or from 10 ppb to 200 ppb, particularly preferably from 1 ppb to 80 ppb;
[I] metal content of metals which are different to aluminium of less than 1000 ppb, preferably in a range from 1 to 900 ppb, for example in a range from 1 to 700 ppb, particularly preferably in a range from 1 to 500 ppb;
[J] a residual moisture content of less than 10 wt.-%, preferably in a range from 0.01 wt.-% to 5 wt. %, for example from 0.02 to 1 wt.-%, particularly preferably from 0.03 to 0.5 wt.-%;
wherein the wt.-%, ppm and ppb are each based on the total weight of the silicon dioxide granulate I.

The OH content, or hydroxyl group content, means the content of OH groups in a material, for example in silicon dioxide powder, in silicon dioxide granulate or in a quartz glass body. The content of OH groups is measured spectroscopically in the infrared by comparing the first and the third OH bands.

The chlorine content means the content of elemental chlorine or chlorine ions in the silicon dioxide granulate, in the silicon dioxide powder or in the quartz glass body.

The aluminium content means the content of elemental aluminium or aluminium ions in the silicon dioxide granulate, in the silicon dioxide powder or in the quartz glass body.

Preferably, the silicon dioxide granulate I has a micro pore proportion in a range from 4 to 5 m²/g; for example in a range from 4.1 to 4.9 m²/g; particularly preferably in a range from 4.2 to 4.8 m²/g.

The silicon dioxide granulate I preferably has a density in a range from 2.1 to 2.3 g/cm³, particularly preferably in a range from 2.18 to 2.22 g/cm³.

The silicon dioxide granulate I preferably has a mean particle size in a range from 180 to 300 μm, for example in a range from 220 to 280 μm, particularly preferably in a range from 230 to 270 μm.

The silicon dioxide granulate I preferably has a particle size D₅₀ in a range from 150 to 300 μm, for example in a range from 180 to 280 μm, particularly preferably in a range from 220 to 270 μm. Furthermore, preferably, the silicon dioxide granulate I has a particle size D₁₀ in a range from 50 to 150 μm, for example in a range from 80 to 150 μm, particularly preferably in a range from 100 to 150 μm. Furthermore, preferably, the silicon dioxide granulate I has a particle size D₉₀ in a range from 250 to 620 μm, for example in a range from 280 to 550 μm, particularly preferably in a range from 300 to 450 μm.

The silicon dioxide granulate I preferably has the feature combination [A]/[B]/[C] or [A]/[B]/[E] or [A]/[B]/[G], further preferably the feature combination [A]/[B]/[C]/[E] or [A]/[B]/[C]/[G] or [A]/[B]/[E]/[G], particularly preferably the feature combination [A]/[B]/[C]/[E]/[G].

The silicon dioxide granulate I preferably has the feature combination [A]/[B]/[C], wherein the BET surface area is in a range from 20 to 40 m²/g, the mean particle size is in a range from 180 to 300 μm and the bulk density is in a range from 0.6 to 1.1 g/mL.

The silicon dioxide granulate I preferably has the feature combination [A]/[B]/[E], wherein the BET surface area is in a range from 20 to 40 m²/g, the mean particle size is in a range from 180 to 300 μm and the aluminium content is in a range from 1 to 50 ppb.

The silicon dioxide granulate I preferably has the feature combination[A]/[B]/[G], wherein the BET surface area is in a range from 20 to 40 m²/g, the mean particle size is in a range from 180 to 300 μm and the pore volume is in a range from 0.2 to 0.8 mL/g.

The silicon dioxide granulate I preferably has the feature combination [A]/[B]/[C]/[E], wherein the BET surface area is in a range from 20 to 40 m²/g, the mean particle size is in a range from 180 to 300 μm, the bulk density is in a range from 0.6 to 1.1 g/mL and the aluminium content is in a range from 1 to 50 ppb.

The silicon dioxide granulate I preferably has the feature combination [A]/[B]/[C]/[G], wherein the BET surface area is in a range from 20 to 40 m²/g, the mean particle size is in a range from 180 to 300 μm, the bulk density is in a range from 0.6 to 1.1 g/mL and the pore volume is in a range from 0.2 to 0.8 mL/g.

The silicon dioxide granulate I preferably has the feature combination [A]/[B]/[E]/[G], wherein the BET surface area is in a range from 20 to 40 m²/g, the mean particle size is in a range from 180 to 300 μm, the aluminium content is in a range from 1 to 50 ppb and the pore volume is in a range from 0.2 to 0.8 mL/g.

The silicon dioxide granulate I preferably has the feature combination [A]/[B]/[C]/[E]/[G], wherein the BET surface area is in a range from 20 to 40 m²/g, the mean particle size is in a range from 180 to 300 μm, the bulk density is in a range from 0.6 to 1.1 g/mL, the aluminium content is in a range from 1 to 50 ppb and the pore volume is in a range from 0.2 to 0.8 mL/g.

Particle size means the size of the particles of aggregated primary particles, which are present in a silicon dioxide powder, in a slurry or in a silicon dioxide granulate. The mean particle size means the arithmetic mean of all particle sizes of the indicated material. The D₅₀ value indicates that 50% of the particles, based on the total number of particles, are smaller than the indicated value. The D₁₀ value indicates that 10% of the particles, based on the total number of particles, are smaller than the indicated value. The D₉₀ value indicates that 90% of the particles, based on the total number of particles, are smaller than the indicated value. The particle size is measured by the dynamic photo analysis process according to ISO 13322-2:2006-11.

Furthermore, particularly preferably, the silicon dioxide granulate provided in step i.) is the silicon dioxide granulate II. The silicon dioxide granulate II has the following features:
(A) a BET surface area in the range from 10 to 35 m²/g, for example in the range from 10 to 30 m²/g, particularly preferably in a range from 20 to 30 m²/g; and
(B) a mean particle size in a range from 100 to 300 μm, for example in a range from 150 to 280 μm or from 200 to 270 μm, particularly preferably in a range from 230 to 260 μm.

Preferably, the silicon dioxide granulate II has at least one, for example at least two or at least three or at least four, particularly preferably at least five of the following features:
(C) a bulk density in a range from 0.7 to 1.2 g/cm³, for example in a range from 0.75 to 1.1 g/cm³, particularly preferably in a range from 0.8 to 1.0 g/cm³;
(D) a carbon content of less than 5 ppm, for example less than 4.5 ppm or in a range from 1 ppb to 4 ppm, particularly preferably of less than 4 ppm;
(E) an aluminium content of less than 200 ppb, for example of less than 150 ppb or of less than 100 ppb or from 1 to 150 ppb or from 1 to 100 ppb, particularly preferably in a range from 1 to 80 ppb;
(F) a tamped density in a range from 0.7 to 1.2 g/cm³, for example in a range from 0.75 to 1.1 g/cm³, particularly preferably in a range from 0.8 to 1.0 g/cm³;
(G) a pore volume in a range from 0.1 to 2.5 mL/g, for example in a range from 0.2 to 1.5 mL/g; particularly preferably in a range from 0.4 to 1 mL/g;
(H) a chlorine content of less than 500 ppm, preferably of less than 400 ppm, for example less than 350 ppm or preferably of less than 330 ppm or in a range from 1 ppb to 500 ppm or from 10 ppb to 450 ppm particularly preferably from 50 ppb to 300 ppm;
(I) a metal content of metals which are different to aluminium of less than 1000 ppb, for example in a range from 1 to 400 ppb, particularly preferably in a range from 1 to 200 ppb;
(J) a residual moisture content of less than 3 wt.-%, for example in a range from 0.001 wt.-% to 2 wt. %, particularly preferably from 0.01 to 1 wt.-%,
wherein the wt.-%, ppm and ppb are each based on the total weight of the silicon dioxide granulate II.

Preferably, the silicon dioxide granulate II has a micro pore proportion in a range from 1 to 2 m²/g, for example in a range from 1.2 to 1.9 m²/g, particularly preferably in a range from 1.3 to 1.8 m²/g.

The silicon dioxide granulate II preferably has a density in a range from 0.5 to 2.0 g/cm³, for example from 0.6 to 1.5 g/cm³, particularly preferably from 0.8 to 1.2 g/cm³. The density is measured according to the method described in the test methods.

The silicon dioxide granulate II preferably has a particle size D₅₀ in a range from 150 to 250 μm, for example in a range from 180 to 250 μm, particularly preferably in a range from 200 to 250 μm. Furthermore, preferably, the silicon dioxide granulate II has a particle size D₁₀ in a range from 50 to 150 μm, for example in a range from 80 to 150 μm, particularly preferably in a range from 100 to 150 μm. Furthermore, preferably, the silicon dioxide granulate II has a particle size D₉₀ in a range from 250 to 450 μm, for example in a range from 280 to 420 μm, particularly preferably in a range from 300 to 400 μm.

The silicon dioxide granulate II preferably has the feature combination (A)/(B)/(D) or (A)/(B)/(F) or (A)/(B)/(I), further preferably the feature combination (A)/(B)/(D)/(F) or (A)/(B)/(D)/(I) or (A)/(B)/(F)/(I), particularly preferably the feature combination (A)/(B)/(D)/(F)/(I).

The silicon dioxide granulate II preferably has the feature combination (A)/(B)/(D), wherein the BET surface area is in a range from 10 to 30 m²/g, the mean particle size is in a range from 150 to 280 μm and the carbon content is less than 4 ppm.

The silicon dioxide granulate II preferably has the feature combination (A)/(B)/(F), wherein the BET surface area is in a range from 10 to 30 m²/g, the mean particle size is in a range from 150 to 280 μm and the tamped density is in a range from 0.8 to 1.0 g/mL.

The silicon dioxide granulate II preferably has the feature combination (A)/(B)/(I), wherein the BET surface area is in a range from 10 to 30 m²/g, the mean particle size is in a range from 150 to 280 μm and the metal content of metals different to aluminium is in a range from 1 to 400 ppb.

The silicon dioxide granulate II preferably has the feature combination (A)/(B)/(D)/(F), wherein the BET surface area is in a range from 10 to 30 m²/g, the mean particle size is in a range from 150 to 280 μm, the carbon content is less than 4 ppm and the tamped density is in a range from 0.8 to 1.0 g/mL.

The silicon dioxide granulate II preferably has the feature combination (A)/(B)/(D)/(I), wherein the BET surface area is in a range from 10 to 30 m²/g, the mean particle size is in a range from 150 to 280 μm, the carbon content is less than 4 ppm and the metal content of metals different to aluminium is in a range 1 from to 400 ppb.

The silicon dioxide granulate II preferably has the feature combination (A)/(B)/(F)/(I), wherein the BET surface area is in a range from 10 to 30 m²/g, the mean particle size is in a range from 150 to 280 μm, the tamped density is in a range from 0.8 to 1.0 g/mL and the metal content of metals different to aluminium is in a range from 1 to 400 ppb.

The silicon dioxide granulate II preferably has the feature combination (A)/(B)/(D)/(F)/(I), wherein the BET surface area is in a range from 10 to 30 m²/g, the mean particle size is in a range from 150 to 280 μm, the carbon content is less than 4 ppm, the tamped density is in a range from 0.8 to 1.0 g/mL and the metal content of metals different to aluminium is in a range from 1 to 400 ppb.

### Step ii.)

From the silicon dioxide granulate provided in step i.), a glass melt is made. Preferably, the silicon dioxide granulate is warmed to obtain the glass melt. The warming of the silicon dioxide granulate to obtain a glass melt can in principle by carried out by any way known to the skilled man for this purpose.

### Vacuum Sintering

The warming of the silicon dioxide granulate to obtain a glass melt can be carried out by vacuum sintering. This process is a discontinuous process in which the silicon dioxide granulate is warmed batchwise for melting.

Preferably, the silicon dioxide granulate is warmed in an evacuatable crucible. The crucible is arranged in a melting oven. The crucible can be arranged in a standing or hanging position, preferably hanging. The crucible can be a sinter crucible or a metal sheet crucible. Preferred are rolled metal sheet crucibles made out of multiple sheets which are riveted together. Examples of crucible materials are refractory metals, in particular W, Mo and Ta, graphite or crucibles lined with graphite foil, graphite crucibles being particularly preferred.

During vacuum sintering, the silicon dioxide granulate is warmed in a vacuum for melting. Vacuum means a residual pressure of less than 2 mbar. To this end, the crucible containing the silicon dioxide granulate is evacuated to a residual pressure of less than 2 mbar.

Preferably, the crucible is warmed in the melting oven to a melt temperature in the range from 1500 to 2500° C., for example in the range from 1700 to 2300° C., particularly preferably in the range from 1900 to 2100° C.

The preferred holding time of the silicon dioxide granulate in the crucible at the melt temperature is quantity-dependent. The holding time of the silicon dioxide granulate in the crucible at the melt temperature is preferably 0.5 to 10 hours, for example 1 to 8 hours or 1.5 to 6 hours, particularly preferably 2 to 5 hours.

The silicon dioxide granulate can be agitated during warming. The agitation of the silicon dioxide granulate takes place preferably by stirring, shaking or swirling.

### Gas Pressure Sintering

The warming of the silicon dioxide granulate to obtain a glass melt can take place by gas pressure sintering. This process is a static process in which the silicon dioxide granulate is warmed batchwise for melting.

Preferably, the silicon dioxide granulate is placed in a closable crucible and introduced into a melting oven. Examples of crucible materials are graphite, refractory metals, in particular W, Mo and Ta, or crucibles lined with graphite foil, graphite crucibles being particularly preferred. The crucible comprises at least one gas inlet and at least one gas outlet. Through the gas inlet, gas can be introduced into the interior of the crucible. Through the gas outlet, gas can be let out of the interior of the crucible. Preferably, it is possible to operate the crucible in a gas flow and in a vacuum.

In gas pressure sintering, the silicon dioxide granulate is warmed in the presence of at least one gas or two or more gases for melting. Suitable gases are e.g. H₂, and inert gases (N₂, He, Ne, Ar, Kr) as well as two or more thereof. Preferably, the gas pressure sintering is carried out in a reducing atmosphere, particularly preferably in the presence of H₂ or H₂/He. A gas exchange of air with H₂ or H₂/He takes place.

Preferably, the silicon dioxide granulate is warmed under a gas pressure of more than 1 bar, for example in the range from 2 to 200 bar or from 5 to 200 bar or from 7 to 50 bar, particularly preferably from 10 to 25 bar for melting.

Preferably, the crucible is warmed in the oven to a melt temperature in the range from 1500 to 2500° C., for example in the range from 1550 to 2100° C. or from 1600 to 1900° C., particularly preferably in the range from 1650 to 1800° C.

The preferred holding time of the silicon dioxide granulate in the crucible at the melt temperature under gas pressure is quantity-dependent. Preferably, the holding time of the silicon dioxide granulate in the crucible at the melt temperature for a quantity of 20 kg is 0.5 to 10 hours, for example 1 to 9 hours or 1.5 to 8 hours, particularly preferably 2 to 7 hours.

Preferably, the silicon dioxide granulate is melted first in a vacuum, then in an H₂ atmosphere or an atmosphere comprising H₂ and He, particularly preferably in a counter-current of these gases. In this process, the temperature in the first step is preferably lower than in the further step. The temperature difference between warming in a vacuum and in the presence of the gas or gases is preferably 0 to 200° C., for example 10 to 100° C., particularly preferably 20 to 80° C.

### Formation of a Partially Crystalline Phase Before Melting

In principle, it is also possible that the silicon dioxide granulate is pre-treated before melting. For example, the silicon dioxide granulate can be warmed in such a way that an at least partially crystalline phase is formed before the partially crystalline silicon dioxide granulate is heated for melting.

To form a partially crystalline phase, the silicon dioxide granulate will preferably be warmed under reduced pressure or in the absence of one or more gases. Suitable gases are for example HCl, Cl₂, F₂, O₂, H₂, C₂F₆, air, inert gas (N₂, He, Ne, Ar, Kr) and two or more thereof. Preferably, the silicon dioxide granulate is warmed under reduced pressure.

Preferably, the silicon dioxide granulate is warmed to a treatment temperature at which the silicon dioxide granulate softens without melting completely, for example to a temperature in the range from 1000 to 1700° C. or from 1100 to 1600° C. or from 1200 to 1500° C., particularly preferably to a temperature in the range from 1250 to 1450° C.

Preferably, the silicon dioxide granulate is warmed in a crucible which is arranged in an oven. The crucible can be arranged in a standing or hanging position, preferably hanging. The crucible can be a sinter crucible or a metal sheet crucible. Preferred are rolled metal sheet crucibles made out of multiple sheets which are riveted together. Examples of crucible materials are refractory metals, in particular W, Mo and Ta, graphite or crucibles lined with graphite foil, graphite crucibles being particularly preferred. Preferably, the holding time of the silicon dioxide granulate in the crucible at the treatment temperature is 1 to 6 hours, for example 2 to 5 hours, particularly preferably 3 to 4 hours.

Preferably, the silicon dioxide granulate is warmed in a continuous process, particularly preferably in a rotary kiln. The mean holding time in the oven is preferably 10 to 180 min, for example 20 to 120 min, particularly preferably 30 to 90 min.

Preferably, the oven used for the pre-treatment can be integrated in the feed line to the melting oven in which the silicon dioxide granulate is warmed for melting. Furthermore, preferably, the pre-treatment can be carried out in the melting oven.

According to a preferred embodiment of the first aspect of the invention, the process is characterised in that during the warming during a period t_{T} a temperature T_{T} is held which is below the melting point of silicon dioxide.

Furthermore, preferably, the temperature T_{T} is in a range from 1000 to 1700° C. Preferably, the warming is carried out by heating in two steps, and particularly preferably warming is carried out first to a temperature T_{T1} from 1000 to 1400° C. and then to a temperature T_{T2} from 1600 to 1700° C.

Likewise preferably, the period t_{T} lies in a range from 1 to 20 hours, preferably from 2 to 6 hours. In the case of a two-step warming, the period t_{T1} at the temperature T_{T1} lies in a range from 1 to 10 hours and the period t_{T2} at the temperature T_{T2} in a range from 1 to 10 hours.

According to a further preferred embodiment, the temperature T_{T} lies in a specific range for a period t_{T}. Preferred combinations of temperature T_{T} and period t_{T} of this type are given in the following table:

| Temperature range [° C.] | Period [h] |
|---|---|
| 1000-1400 | 1 to 10 |
| 1000-1400 | 2 to 6 |
| 1600-1700 | 1 to 10 |
| 1600-1700 | 2 to 6 |

According to a further preferred embodiment of the first aspect of the invention, the period T_{T} lies before the making of the glass melt.

### Step iii.)

From at least a part of the glass melt prepared in step ii), a quartz glass body is made.

Preferably, the quartz glass body is made out of at least a part of the glass melt made in step ii). In principle, the quartz glass body can be made out of at least a part of the glass melt in the melting crucible or after removal of at least a part of the glass melt from the melting crucible, preferably after removal of at least a part of the glass melt from the melting crucible.

The removal of a part of the glass melt made in step ii) can be carried out continuously from the melting oven or the melting chamber or after the production of the glass melt has been finished. Preferably, a part of the glass melt is removed continuously. The glass melt is removed through the outlet of the oven or the outlet of the melting chamber, preferably via a nozzle in each case.

The glass melt can be cooled before, during or after the removal, to a temperature which enables the forming of the glass melt. A rise in the viscosity of the glass melt is connected to the cooling of the glass melt. The glass melt is preferably cooled to such an extent that in the forming, the produced form holds and the forming is at the same time as easy and reliable as possible and can be carried out with little effort. The skilled person can easily establish the viscosity of the glass melt for forming by varying the temperature of the glass melt at the forming tool. Preferably, the glass melt is cooled to a temperature of less than 500° C., for example of less than 200° C. or less than 100° C. or less than 50° C., particularly preferably to a temperature in the range from 20 to 30° C.

Furthermore, preferably, the cooling takes place at a rate in a range from 0.1 to 50 K/min, for example from 0.2 to 10 K/min or from 0.3 to 8 K/min or from 0.5 to 5 K/min, particularly preferably in a range from 1 to 3 K/min.

It is further preferred to cool in accordance with the following profile:
1. Cooling to a temperature in a range from 1180 to 1220° C.;
2. Holding at this temperature over a period from 30 to 120 min, for example from 40 to 90 min, particularly preferably from 50 to 70 min;
3. Cooling to a temperature of less than 500° C., for example of less than 200° C. or less than 100° C. or less than 50° C., particularly preferably to a temperature in the range from 20 to 30° C.,
wherein the cooling takes place in each case at a rate in a range from 0.1 to 50 K/min, for example from 0.2 to 10 K/min or from 0.3 to 8 K/min or from 0.5 to 5 K/min, particularly preferably in a range from 1 to 3 K/min.

The quartz glass body which is formed can be a solid body or a hollow body. A solid body means a body which is mainly made out of a single material. Nevertheless, a solid body can have one or more inclusions, e.g. gas bubbles. Such inclusions in a solid body commonly have a size of 65 mm³ or less, for example of less than 40 mm³, or of less than 20 mm³, or of less than 5 mm³, or of less than 2 mm³, particularly preferably of less than 0.5 mm³.

The quartz glass body has an exterior form. The exterior form means the form of the outer edge of the cross section of the quartz glass body. The exterior form of the quartz glass body in cross-section is preferably round, elliptical or polygonal with three or more corners, for example 4, 5, 6, 7 or 8 corners, particularly preferably the quartz glass body is round.

Preferably, the quartz glass body has a length in the range from 100 to 10000 mm, for example from 1000 to 4000 mm, particularly preferably from 1200 to 2000 mm.

Preferably, the quartz glass body has an exterior diameter in the range from 10 to 1500 mm, for example in a range from 50 to 1000 mm or from 100 to 500 mm, particularly preferably in a range from 150 to 300 mm.

The forming of the quartz glass body is performed by means of a nozzle. The glass melt is sent through the nozzle. The exterior form of a quartz glass body formed through the nozzle is determined by the form of the nozzle opening. If the opening is round, a cylinder will be made in the forming of the quartz glass body. The nozzle can be integrated into the melting oven or can be arranged separately. If the nozzle is not integrated into the melting oven, it can be equipped with an upstream container in which the glass melt is introduced after melting and before forming. Preferably, the nozzle is integrated into the melting oven. Preferably, it is integrated into the melting oven as part of the outlet. This process for forming the quartz glass body is preferred if the silicon dioxide granulate is heated for melting in a vertically oriented oven suitable for a continuous process.

The forming of the quartz glass body can take place by making the glass melt in a mould, for example in a formed crucible. Preferably, the glass melt is cooled in the mould and then removed therefrom. The cooling can preferably take place by cooling the mould from the outside. This process for forming the quartz glass body is preferred if the silicon dioxide is heated for melting by means of gas pressure sintering or by means of vacuum sintering.

Preferably, the quartz glass body is cooled after being made. Preferably, the quartz glass body is cooled to a temperature of less than 500° C., for example of less than 200° C. or less than 100° C. or less than 50° C., particularly preferably to a temperature in the range from 20 to 30° C.

Preferably the quartz glass body made in step iii.) is cooled at a rate in a range from 0.1 to 50 K/min, for example from 0.2 to 10 K/min or from 0.3 to 8 K/min or from 0.5 to 5 K/min, particularly preferably in a range from 1 to 3 K/min to room temperature (25° C.). Preferably, this cooling takes place in the mould.

Preferably, the quartz glass body is cooled at least to a temperature of 1300° C. at a rate of up to 5 K/min. Preferably, the cooling of the quartz glass body takes place in a temperature range from 1300 to 1000° C. at a rate of not more than 1 K/min. Often, the quartz glass body is cooled from a temperature of under 1000° C. at a rate of up to 50 K/min.

Preferably, the cooling takes place in accordance with the following profile:
1. Cooling at a cooling rate of not more than 5 K/min to a temperature of 1300° C.
2. Cooling at a cooling rate of not more than 1 K/min to a temperature of 1000° C.
3. Cooling at a cooling rate of not more than 50 K/min to a temperature of 25° C.

Preferably, the process according to the invention comprises the following process step:
iv.) Making a hollow body having at least one opening out of the quartz glass body.

The hollow body which is made has an interior and an exterior form. Interior form means the form of the inner edge of the cross section of the hollow body. The interior and exterior form in cross section of the hollow body can be the same or different. The interior and exterior form of the hollow body in cross section can be round, elliptical or polygonal with three or more corners, for example 4, 5, 6, 7 or 8 corners.

Preferably, the exterior form of the cross section corresponds to the interior form of the hollow body. Particularly preferably, the hollow body has in cross section a round interior and a round exterior form.

In another embodiment, the hollow body can differ in the interior and exterior form. Preferably, the hollow body has in cross section a round exterior form and a polygonal interior form. Particularly preferably, the hollow body in cross section has a round exterior form and a hexagonal interior form.

Preferably, the hollow body has a length in the range from 100 to 10000 mm, for example from 1000 to 4000 mm, particularly preferably from 1200 to 2000 mm.

Preferably, the hollow body has a wall thickness in a range from 1 to 1000 mm, for example in a range from 10 to 500 mm or from 30 to 200 mm, particularly preferably in a range from 50 to 125 mm.

Preferably, the hollow body has an outer diameter of 10 to 1500 mm, for example in a range from 50 to 1000 mm or from 100 to 500 mm, particularly preferably in a range from 150 to 300 mm.

Preferably, the hollow body has an inner diameter of 1 to 500 mm, for example in a range from 5 to 300 mm or from 10 to 200 mm, particularly preferably in a range from 20 to 100 mm.

The hollow body comprises one or more openings. Preferably, the hollow body comprises one opening. Preferably, the hollow body has an even number of openings, for example 2, 4, 6, 8, 10, 12, 14, 16, 18 or 20 openings.

Preferably, the hollow body comprises two openings. Preferably, the hollow body is a tube. This form of the hollow body is particularly preferred if the light guide comprises only one core.

The hollow body can comprise more than two openings. The openings are preferably located in pairs situated opposite each other at the ends of the quartz glass body. For example, each end of the quartz glass body can have 2, 3, 4, 5, 6, 7 or more than 7 openings, particularly preferably 5, 6 or 7 openings.

The hollow body can in principle be formed by any method known to the skilled person. Preferably, the hollow body is formed by means of a nozzle. Preferably, the nozzle comprises in the middle of its opening a device which deviates the glass melt in the forming. In this way, a hollow body can be formed from a glass melt.

A hollow body can be made by the use a nozzle and subsequent post treatment. Suitable post treatments are in principle all process known to the skilled person for making a hollow body out of a solid body, for example compressing channels, drilling, honing or grinding. Preferably, a suitable post treatment is to send the solid body over one or multiple mandrels, whereby a hollow body is formed. Also, the mandrel can be introduced into the solid body to make a hollow body. Preferably, the hollow body is cooled after the forming.

The forming into a hollow body can take place by making the glass melt in a mould, for example in a formed crucible. Preferably, the glass melt is cooled in the mould and then removed therefrom. The cooling can preferably take place by cooling the mould from the outside.

Preferably, the hollow body is cooled to a temperature of less than 500° C., for example less than 200° C. or less than 100° C. or less than 50° C., particularly preferably to a temperature in the range from 20 to 30° C.

Preferably, the hollow body made in step iii.) is cooled at a rate in a range from 0.1 to 50 K/min, for example from 0.2 to 10 K/min or from 0.3 to 8 K/min or from 0.5 to 5 K/min, particularly preferably in a range from 1 to 3 K/min down to room temperature (25° C.).

Preferably, the hollow body is cooled at least to a temperature of 1300° C. at a rate of up to 5 K/min. Preferably, the cooling of the quartz glass body takes place in a temperature range from 1300 to 1000° C. at a rate of not more than 1 K/min. Often, the hollow body is cooled from a temperature of under 1000° C. at a rate of up to 50 K/min.

Preferably, the cooling takes place in accordance with the following profile:
1. Cooling at a cooling rate of not more than 5 K/min to a temperature of 1300° C.
2. Cooling at a cooling rate of not more than 1 K/min to a temperature of 1000° C.
3. Cooling at a cooling rate of not more than 50 K/min to a temperature of 25° C.

The quartz glass body made by the process according to the first aspect of the invention has the following properties:
A] an OH content of less than 10 ppm, for example of less than 5 ppm or of less than 2 ppm, particularly preferably in a range from 1 ppb to 1 ppm;
B] a chlorine content of less than 60 ppm;
C] an aluminium content of less than 200 ppb, for example less than 100 ppb, particularly preferably less than 80 ppb;
wherein the ppb and ppm are each based on the total weight of the quartz glass body.

According to a preferred embodiment, the quartz glass body made according to the first aspect is transparent and low in bubbles. “Transparent” means the transmission of light in the visible range. Preferably, the intensity of the incident light to the intensity of the emergent light in the range from 400 to 700 nm is at least 80%.

Preferably, a quartz glass body has at least one, for example at least two or at least three or at least four, particularly preferably at least five of the following features:
D] a fictive temperature in a range from 1055 to 1200° C.;
E] an ODC content of less than 5×10¹⁵/cm³, for example in a range from 0.1×10¹⁵ to 3×10¹⁵/cm³, particularly preferably in a range from 0.5×10¹⁵ to 2.0×10¹⁵/cm³;
F] a metal content of metals which are different to aluminium of less than 300 ppb, for example of less than 200 ppb, particularly preferably in a range from 1 to 150 ppb;
G] a viscosity (p=1013 hPa) in a range from log₁₀ (η (1200° C.)/dPas)=13.4 to log₁₀ (η (1200° C.)/dPas)=13.9 and/or log₁₀ (η (1300° C.)/dPas)=11.5 to log₁₀ (η (1300° C.)/dPas)=12.1 and/or log₁₀ (q (1350° C.)/dPas)=1.2 to log₁₀ (η (1350° C.)/dPas)=10.8;
H] a standard deviation of the OH content of not more than 10%, preferably not more than 5%, based on the OH content A] of the quartz glass body;
I] a standard deviation of the Cl content of not more than 10%, preferably not more than 5%, based on the Cl content B] of the quartz glass body;
J] a standard deviation of the Al content of not more than 10%, preferably not more than 5%, based on the Al content C] of the quartz glass body;
K] a refractive index homogeneity of less than 1×10⁻⁴, for example of less than 5×10⁵, particularly preferably of less than 1×10⁻⁶;
L] a transformation point Tg in a range from 1150 to 1250° C.;
wherein the ppb and ppm are each based on the total weight of the quartz glass body.

The quartz glass body preferably has the feature combination A]/B]/C]/D] or A]/B]/C]/E] or A]/B]/C]/G], further preferably the feature combination A]/B]/C]/D]/E] or A]/B]/C]/D]/G] or A]/B]/C]/E]/G], particularly preferably the feature combination A]/B]/C]/D]/E]/G.

The quartz glass body preferably has the feature combination A]/B]/C]/D], wherein the OH content is less than 5 ppm, the chlorine content is less than 60 ppm, the aluminium content is less than 100 ppb and the fictive temperature is in a range from 1055 to 1200° C.

The quartz glass body preferably has the feature combination A]/B]/C]/E], wherein the OH content is less than 5 ppm, the chlorine content is less than 60 ppm, the aluminium content is less than 100 ppb and the ODC content is in a range from 0.1×10¹⁵ to 3×10¹⁵/cm³.

The quartz glass body preferably has the feature combination A]/B]/C]/G], wherein the OH content is less than 5 ppm, the chlorine content is less than 60 ppm, the aluminium content is less than 100 ppb and the viscosity (p=1013 hPa) is in a range from log₁₀ (η (1200° C.)/dPas)=13.4 to log₁₀ (η (1200° C.)/dPas)=13.9.

The quartz glass body preferably has the feature combination A]/B]/C]/D]/E], wherein the OH content is less than 5 ppm, the chlorine content is less than 60 ppm, the aluminium content is less than 100 ppb, the fictive temperature is in a range from 1055 to 1200° C. and the ODC content is in a range from 0.1×10¹⁵ to 3×10¹⁵/cm³.

The quartz glass body preferably has the feature combination A]/B]/C]/D]/G], wherein the OH content is less than 5 ppm, the chlorine content is less than 60 ppm, the aluminium content is less than 100 ppb, the fictive temperature is in a range from 1055 to 1200° C. and the viscosity (p=1013 hPa) is in a range from log₁₀ (η (1200° C.)/dPas)=13.4 to log₁₀ (η (1200° C.)/dPas)=13.9.

The quartz glass body preferably has the feature combination A]/B]/C]/E]/G], wherein the OH content is less than 5 ppm, the chlorine content is less than 60 ppm, the aluminium content is less than 100 ppb, the ODC content is in a range from 0.1×10¹⁵ to 3×10¹⁵/cm³ and the viscosity (p=1013 hPa) is in a range from log₁₀ (η (1200° C.)/dPas)=13.4 to log₁₀ (η (1200° C.)/dPas)=13.9.

The quartz glass body preferably has the feature combination A]/B]/C]/D]/E]/G], wherein the OH content is less than 5 ppm, the chlorine content is less than 60 ppm, the aluminium content is less than 100 ppb, the fictive temperature is in a range from 1055 to 1200° C., the ODC content is in a range from 0.1×10¹⁵ to 3×10¹⁵/cm³ and the viscosity (p=1013 hPa) is in a range from log₁₀ (η (1200° C.)/dPas)=13.4 to log₁₀ (η (1200° C.)/dPas)=13.9.

A second aspect of the present invention is a quartz glass body obtainable by the process according to the first aspect of the invention.

For preferred embodiments of the quartz glass body obtained in this way and of the process, reference is made to the preferred embodiments described for the first aspect. These are also preferred embodiments of this aspect of the invention.

A third aspect of the present invention is a quartz glass body comprising pyrogenic silicon dioxide, wherein the quartz glass body has the following features:
A] an OH content of less than 10 ppm;
B] a chlorine content of less than 60 ppm; and
C] an aluminium content of less than 200 ppb,
wherein the ppb and ppm are each based on the total weight of the quartz glass body.

Preferably, the quartz glass body is characterised by at least one, for example at least two or at least three or at least four, particularly preferably all of the following features:
D] a fictive temperature in a range from 1055 to 1200° C.;
E] an ODC content of less than 5×10¹⁵/cm³, for example in a range from 0.1×10¹⁵ to 3×10¹⁵/cm³, particularly preferably in a range from 0.5×10¹⁵ to 2.0×10¹⁵/cm³;
F] a metal content of metals which are different to aluminium, of less than 300 ppb, for example of less than 200 ppb, particularly preferably in a range from 1 to 150 ppb;
G] a viscosity (p=1013 hPa) in a range from log₁₀ (η (1200° C.)/dPas)=13.4 to log₁₀ (η (1200° C.)/dPas)=13.9 and/or log₁₀ (η (1300° C.)/dPas)=11.5 to log₁₀ (η (1300° C.)/dPas)=12.1 and/or log₁₀ (η (1350° C.)/dPas)=1.2 to log₁₀ (η (1350° C.)/dPas)=10.8;
H] a standard deviation of the OH content of not more than 10%, preferably not more than 5%, based on the OH content A] of the quartz glass body;
I] a standard deviation of the Cl content of not more than 10%, preferably not more than 5%, based on the Cl content B] of the quartz glass body;
J] a standard deviation of the Al content of not more than 10%, preferably not more than 5%, based on the Al content C] of the quartz glass body;
K] a refractive index homogeneity of less than 1×10⁻⁴, for example of less than 5×10⁵, particularly preferably of less than 1×10⁻⁶;
L] a transformation point Tg in a range from 1150 to 1250° C.;
wherein the ppb and ppm are each based on the total weight of the quartz glass body.

For preferred embodiments of this aspect, reference is made to the preferred embodiments described for the first and second aspects. These are also preferred embodiments of this aspect of the invention.

The quartz glass body preferably has a homogeneously distributed quantity of OH, chorine or aluminium. An indicator of the homogeneity of the quartz glass body can be expressed in the standard deviation of the quantity of OH, chlorine or aluminium. The standard deviation is the measure of the spread of the values of a variable from their arithmetic mean, here the OH content, chlorine content or aluminium content. For measuring the standard deviation, the content in the sample of the component in question, e.g. OH, chlorine or aluminium, is measured at a minimum of seven measuring locations.

A fourth aspect of the invention is a process for the preparation of a formed body comprising the following process steps:
(1) Providing a quartz glass body according to the second or third aspect of the invention;
(2) Making the formed body from the quartz glass body.

The quartz glass body provided in step (1) is a quartz glass body according to the second or third aspect of the invention or obtainable by a process according to the first aspect of the invention. Preferably, the quartz glass body provided has the features described in the context of the first, second or third aspect of the invention.

### Step (2)

The making of the formed body from the quartz glass body can in principle be performed in any way known to the skilled person and which is suitable for the present purpose. The making is preferably a forming.

For forming the quartz glass body provided in step (1), in principle any processes known to the skilled person and which are suitable for forming quartz glass are possible. Preferably, the quartz glass body is formed as described in the context of the first aspect of the invention to obtain a formed body. Furthermore, preferably, the formed body can be formed by means of techniques known to glass blowers.

The formed body can in principle take any shape which is formable out of quartz glass. Preferred formed bodies are for example:
hollow bodies with at least one opening such as round bottomed flasks and standing flasks,
fixtures and caps for such hollow bodies,
open articles such as bowls and boats (wafer carrier),
crucibles, arranged either open or closable,
sheets and windows,
cuvettes,
tubes and hollow cylinders, for example reaction tubes, section tubes, cuboid chambers,
rods, bars and blocks, for example in round or angular, symmetric or asymmetric format,
tubes and hollow cylinders closed off at one end or both ends,
domes and bells,
flanges,
lenses and prisms,
parts welded to each other,
curved parts, for example convex or concave surfaces and sheets, curved rods and tubes.

According to a preferred embodiment, the formed body can be treated after the forming. For this, in principle all processes described in connection with the first aspect of the invention which are suitable for post treatment of the quartz glass body are possible. Preferably, the formed body can be mechanically processed, for example by drilling, honing, external grinding, reducing in size or drawing.

A fifth aspect of the invention relates to a formed body obtainable by a process according to the fourth aspect of the invention. The process comprising the following steps:
(1) Providing a quartz glass body according to the second or third aspect of the invention;
(2) Forming the quartz glass body to obtain the formed body.

The steps (1) and (2) are preferably characterised by the features described in the context of the fourth aspect.

The formed body is preferably characterised by the features described in the context of the fourth aspect.

A sixth aspect of the present invention relates to a process for the production of a structure comprising the following process steps:
a/ Providing a formed body according to the fourth or fifth aspect of the invention and a part, preferably several parts, the one or several parts preferably being composed of quartz glass;
b/ Joining the formed body with the part to obtain the structure.

Suitable as parts are any parts that are known to the skilled person and that seem suitable for joining to a formed body composed of quartz glass. In particular, these are pipes, flanges and forms such as have already been described for the formed body.

The above-mentioned part can comprise quartz glass or a material different from quartz glass or can consist of this material. The material is preferably selected from the group consisting of glass, metal, ceramic and plastic or a combination of the aforementioned materials.

The joining of the formed body with the part or parts can, in principle, take place in any known way that is known to the skilled person for joining the formed body to the part or parts. Preferred types of joining are joints produced each independently of one another for each individual joint, particularly by material bonding or positive mechanical engagement. Preferred joints by material bonding are welding and adhesion. Preferred joints by positive mechanical engagement are screwing, pressing and riveting. More preferably, combinations of positive mechanical engagement and material bonding in a single joint can be selected, e.g. screwing and at the same time adhesion, or in several joints present within one structure.

According to a preferred embodiment, the structure has homogeneous material properties. These preferably include a homogeneous material distribution, a homogeneous viscosity distribution, homogeneous optical properties and combinations thereof.

A seventh aspect of the present invention relates to a structure obtainable by the above-described process according to the invention for producing a structure (sixth aspect of the invention). In this regard, reference is made to the above-described aspects and embodiments.

### FIGURES

FIG. 1 flow diagram (process for the preparation of a quartz glass body)

FIG. 2 flow diagram (process for the preparation of a silicon dioxide granulate I)

FIG. 3 flow diagram (process for the preparation of a silicon dioxide granulate II)

FIG. 4 schematic representation of a spray tower

FIG. 5 schematic representation of a gas pressure sinter oven (GDS oven)

FIG. 6 flow diagram (process for the preparation of a formed body)

### DESCRIPTION OF THE FIGURES

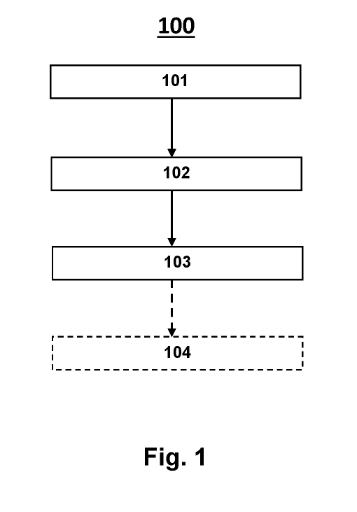

FIG. 1 shows a flow diagram containing the steps 101 to 104 of a process 100 for the preparation of a quartz glass body according to the present invention. In a first step 101, a silicon dioxide granulate is provided. In a second step 102, a glass melt is made from the silicon dioxide granulate.

Preferably, moulds are used for the melting which can be introduced into and removed from an oven. Such moulds are often made of graphite. They provide a negative form for the cast item. The silicon dioxide granulate is filled into the mould and is first melted in the mould in step 103. Subsequently, the quartz glass body is formed in the same mould by cooling the melt. It is then freed from the mould and processed further, for example in an optional step 104. This procedure is discontinuous. The forming of the melt is preferably performed at reduced pressure, in particular in a vacuum. Further, it is possible during step 103 to charge the oven intermittently with a reducing, hydrogen containing atmosphere.

In another procedure, hanging or standing crucibles are preferably employed as the melting crucible. To this end, the silicon dioxide granulate is introduced into the melting crucible here and warmed therein until a glass melt forms. The melting preferably takes place in this case in a reducing, hydrogen-containing atmosphere. In a third step 103, a quartz glass body is formed. The formation of the quartz glass body is preferably performed by removing at least a part of the glass melt from the crucible and cooling, for example through a nozzle at the lower end of the crucible. In this case, the form of the quartz glass body can be determined partly by the design of the nozzle.

In this way, for example, solid bodies can be obtained. Hollow bodies are obtained for example if the nozzle additionally has a mandrel. This examplary representation of a process for the preparation of quartz glass bodies, and in particular step 103, is preferably performed continuously. In an optional step 104, a hollow body can be formed from a solid quartz glass body.

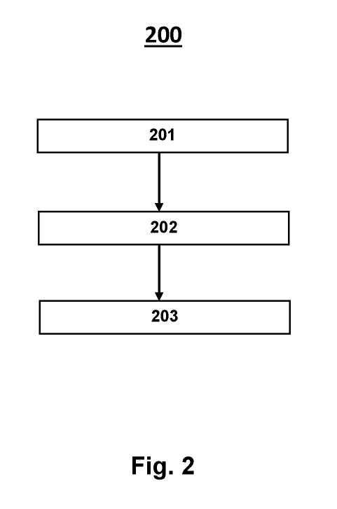

FIG. 2 shows a flow diagram containing the steps 201, 202 and 203 of a process 200 for the preparation of a silicon dioxide granulate I. In a first step 201, a silicon dioxide powder is provided. A silicon dioxide powder is preferably obtained from a synthetic process in which a silicon containing material, for example a siloxane, a silicon alkoxide or a silicon halide is converted into silicon dioxide in a pyrogenic process. In a second step 202, the silicon dioxide powder is mixed with a liquid, preferably with water, to obtain a slurry. In a third step 203, the silicon dioxide contained in the slurry is transformed into a silicon dioxide granulate. The granulation is performed by spray granulation. For this, the slurry is sprayed through a nozzle into a spray tower and dried to obtain granules, wherein the contact surface between the nozzle and the slurry comprises a glass or a plastic.

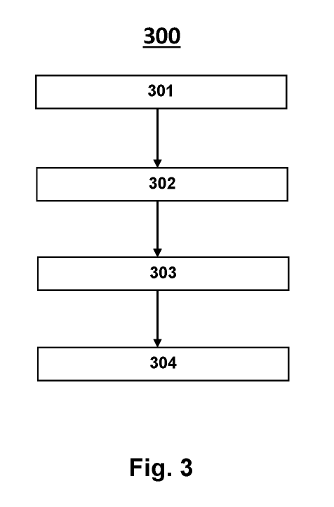

FIG. 3 shows a flow diagram containing the steps 301, 302, 303 and 304 of a process 300 for the preparation of a silicon dioxide granulate II. The steps 301, 302 and 303 proceed corresponding to the steps 201, 202 and 203 according to FIG. 2. In step 304, the silicon dioxide granulate I obtained in step 303 is processed to obtain a silicon dioxide granulate II. This is preferably performed by warming the silicon dioxide granulate I in a chlorine containing atmosphere.

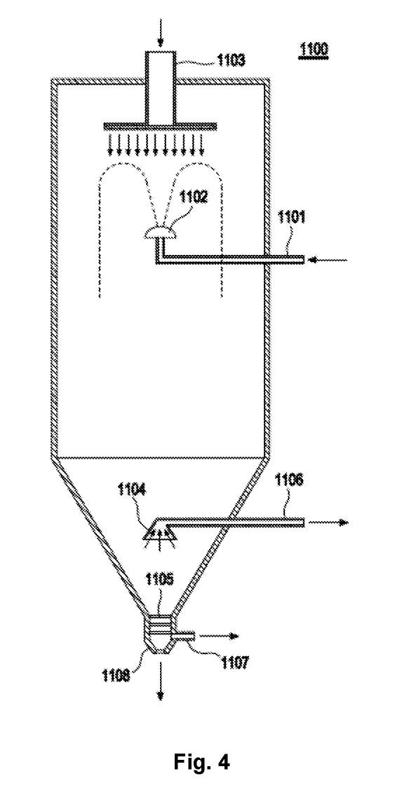

In FIG. 4 is shown a preferred embodiment of a spray tower 1100 for spray granulating silicon dioxide. The spray tower 1100 comprises a feed 1101 through which a pressurised slurry containing silicon dioxide powder and a liquid are fed into the spray tower. At the end of the pipeline is a nozzle 1102 through which the slurry is introduced into the spray tower as a finely spread distribution. Preferably, the nozzle slopes upward, so that the slurry is sprayed into the spray tower as fine droplets in the nozzle direction and then falls down in an arc under the influence of gravity. At the upper end of the spray tower there is a gas inlet 1103. By introduction of a gas through the gas inlet 1103, a gas flow is created in the opposite direction to the exit direction of the slurry out of the nozzle 1102. The spray tower 1100 also comprises a screening device 1104 and a sieving device 1105. Particles which are smaller than a defined particle size are extracted by the screening device 1104 and removed through the discharge 1106. The extraction strength of the screening device 1104 can be configured to correspond to the particle size of the particles to be extracted. Particles above a defined particle size are sieved off by the sieving device 1105 and removed through the discharge 1107. The sieve permeability of the sieving device 1105 can be selected to correspond to the particle size to be sieved off. The remaining particles, a silicon dioxide granulate having the desired particle size, is removed through the outlet 1108.

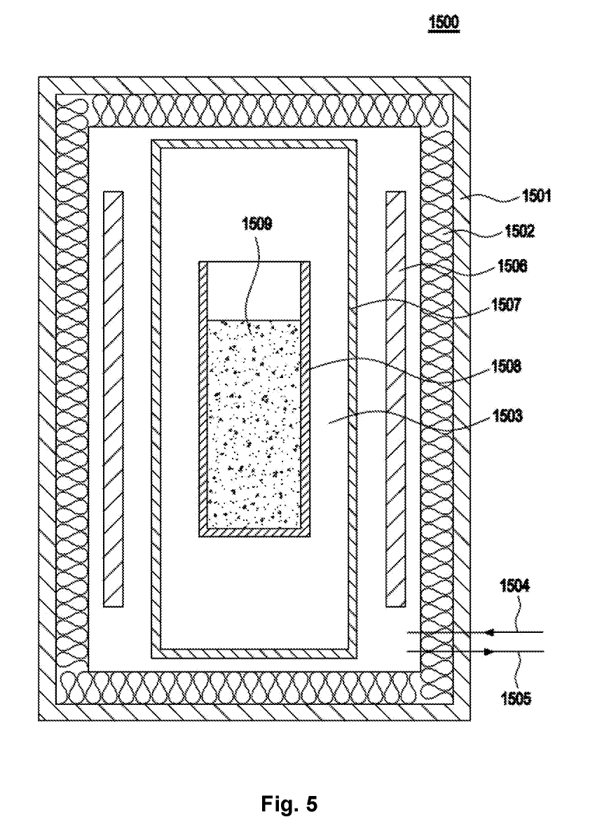

FIG. 5 shows a preferred embodiment of the oven 1500 which is suitable for a vacuum sintering process, a gas pressure sinter process and in particular a combination thereof. The oven has from outside inward a pressure resistant jacket 1501 and a thermal insulating layer 1502. The space enclosed thereby, referred to as the oven interior, can be charged with a gas or a gas mixture via a gas feed 1504. Further, the oven interior has a gas outlet 1505 via which gas can be removed. According to the gas transport balance between gas feed 1504 and gas removal at 1505 an over pressure, a vacuum or also a gas flow can be produced in the interior of the oven 1500. Further, heating elements 1506 are present in the oven interior 1500. These are often mounted on the insulation layer 1502 (not shown here). For protecting the melt material from contamination, there is a so-called “liner” 1507 in the interior of the oven, which separates the oven chamber 1503 from the heating elements 1506. Moulds 1508 with material to be melted 1509 can be introduced into the oven chamber 1503. The mould 1508 can be open on a side (shown here) or can completely enclose the melt material 1509 (not shown).

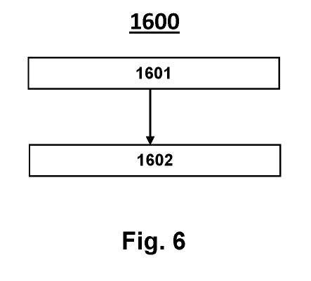

FIG. 6 shows a flow diagram containing the steps 1601 and 1602 of a process for the preparation of a formed body. In the first step 1601, a quartz glass body is provided, preferably a quartz glass body prepared according to FIG. 100. Such a quartz glass body can be a solid or hollow body quartz glass body. In a second step 1602, a formed body is formed from a solid quartz glass body provided in step 1601.

### Test Methods

a. Fictive Temperature

The fictive temperature is measured by Raman spectroscopy using the Raman scattering intensity at about 606 cm⁻¹. The procedure and analysis described in the contribution of Pfleiderer et. al.; “The UV-induced 210 nm absorption band in fused Silica with different thermal history and stoichiometry”; Journal of Non-Crystalline Solids, volume 159 (1993), pages 145-153.

b. OH Content

The OH content of the glass is measured by infrared spectroscopy. The method of D. M. Dodd & D. M. Fraser “Optical Determinations of OH in Fused Silica” (J.A.P. 37, 3991 (1966)) is employed. Instead of the device named therein, an FTIR-spectrometer (Fourier transform infrared spectrometer, current System 2000 of Perkin Elmer) is employed. The analysis of the spectra can in principle be performed on either the absorption band at ca. 3670 cm⁻¹ or on the absorption band at ca. 7200 cm⁻¹. The selection of the band is made on the basis that the transmission loss through OH absorption is between 10 and 90%.

c. Oxygen Deficiency Centers (ODCs)

For the quantitative detection, the ODC(I) absorption is measured at 165 nm by means of a transmission measurement at a probe with thickness between 1-2 mm using a vacuum UV spectrometer, model VUVAS 2000, of McPherson, Inc. (USA).

### Then:

N=α/σ
with
   N=defect concentration [1/cm³]
   α=optical absorption [1/cm, base e] of the ODC(I) band
   σ=effective cross section [cm²]
wherein the effective cross section is set to σ=7.5×10⁻¹⁷ cm² (from L. Skuja, “Color Centers and Their Transformations in Glassy SiO₂”, Lectures of the summer school “Photosensitivity in optical Waveguides and glasses”, July 13-18 1998, Vitznau, Switzerland).
   d. Elemental Analysis

d-1) Solid samples are crushed. Then, ca. 20 g of the sample is cleaned by introducing it into a HF-resistant vessel fully, covering it with HF and thermally treating at 100° C. for an hour. After cooling, the acid is discarded and the sample cleaned several times with high purity water. Then, the vessel and the sample are dried in the drying cabinet.

Next, ca. 2 g of the solid sample (crushed material cleaned as above; dusts etc. without pre-treatment) is weighed into an HF resistant extraction vessel and dissolved in 15 ml HF (50 wt.-%). The extraction vessel is closed and thermally treated at 100° C. until the sample is completely dissolved. Then, the extraction vessel is opened and further thermally treated at 100° C., until the solution is completely evaporated. Meanwhile, the extraction vessel is filled 3x with 15 ml of high purity water. 1 ml HNO₃ is introduced into the extraction vessel, in order to dissolve separated impurities and filled up to 15 ml with high purity water. The sample solution is then ready.

d-2) ICP-MS/ICP-OES Measurement

Whether OES or MS is employed depends on the expected elemental concentrations. Typically, measurements of MS are lppb, and for OES they are 10 ppb (in each case based on the weighed sample). The measurement of the elemental concentration with the measuring devices is performed according to the stipulations of the device manufacturer (ICP-MS: Agilent 7500ce; ICP-OES: Perkin Elmer 7300 DV) and using certified reference liquids for calibration. The elemental concentrations in the solution (15 ml) measured by the device are then converted based on the original weight of the probe (2 g).

Note: It is to be kept in mind that the acid, the vessels, the water and the devices must be sufficiently pure in order to measure the elemental concentrations in question. This is checked by extracting a blank sample without quartz glass.

The following elements are measured in this way: Li, Na, Mg, K, Ca, Fe, Ni, Cr, Hf, Zr, Ti, (Ta), V, Nb, W, Mo, Al.

d-3) The measurement of samples present as a liquid is carried out as described above, wherein the sample preparation according to step d-1) is skipped. 15 ml of the liquid sample are introduced into the extraction flask. No conversion based on the original sample weight is made.

e. Determination of Density of a Liquid

For measuring the density of a liquid, a precisely defined volume of the liquid is weighed into a measuring device which is inert to the liquid and its constituents, wherein the empty weight and the filled weight of the vessel are measured. The density is given as the difference between the two weight measurements divided by the volume of the liquid introduced.

f. Fluoride Determination

15 g of a quartz glass sample is crushed and cleaned by treating in nitric acid at 70° C. The sample is then washed several times with high purity water and then dried. 2 g of the sample is weighed into a nickel crucible and covered with 10 g Na₂CO₃ and 0.5 g ZnO. The crucible is closed with a Ni-lid and roasted at 1000° C. for an hour. The nickel crucible is then filled with water and boiled up until the melt cake has dissolved entirely. The solution is transferred to a 200 ml measuring flask and filled up to 200 ml with high purity water. After sedimentation of undissolved constituents, 30 ml are taken and transferred to a 100 ml measuring flask, 0.75 ml of glacial acetic acid and 60 ml TISAB are added and filled up with high purity water. The sample solution is transferred to a 150 ml glass beaker.

The measurement of the fluoride content in the sample solution is performed by means of an ion sensitive (fluoride) electrode, suitable for the expected concentration range, and display device as stipulated by the manufacturer, here a fluoride ion selective electrode and reference electrode F-500 with R503/D connected to a pMX 3000/pH/ION from Wissenschaftlich-Technische Werkstatten GmbH. With the fluoride concentration in the solution, the dilution factor and the sample weight, the fluoride concentration in the quartz glass is calculated.

g. Determination of Chlorine (>=50 ppm)

15 g of a quartz glass sample is crushed and cleaned by treating with nitric acid at ca. 70° C. Subsequently, the sample is rinsed several times with high purity water and then dried. 2 g of the sample are then filled into a PTFE-insert for a pressure container, dissolved with 15 ml NaOH (c=10 mol/l), closed with a PTFE lid and placed in the pressure container. It is closed and thermally treated at ca. 155° C. for 24 hours. After cooling, the PTFE insert is removed and the solution is transferred entirely to a 100 ml measuring flask. There, 10 ml HNO₃ (65 wt.-%) and 15 ml acetate buffer and added, allowed to cool and filled to 100 ml with high purity water. The sample solution is transferred to a 150 ml glass beaker. The sample solution has a pH value in the range between 5 and 7.

The measurement of the chloride content in the sample solution is performed by means of an ion sensitive (Chloride) electrode which is suitable for the expected concentration range, and a display device as stipulated by the manufacturer, here an electrode of type Cl-500 and a reference electrode of type R-503/D attached to a pMX 3000/pH/ION from Wissenschaftlich-Technische Werkstitten GmbH.

h. Chlorine Content (<50 ppm)

Chlorine content <50 ppm up to 0.1 ppm in quartz glass is measured by neutron activation analysis (NAA). For this, 3 bores, each of 3 mm diameter and 1 cm long are taken from the quartz glass body under investigation. These are given to a research institute for analysis, in this case to the institute for nuclear chemistry of the Johannes-Gutenberg University in Mainz, Germany. In order to exclude contamination of the sample with chlorine, a thorough cleaning of the sample in an HF bath on location directly before the measurement was arranged. Each bore is measured several times. The results and the bores are then sent back by the research institute.

i. Optical Properties

The transmission of quartz glass samples is measured with the commercial grating- or FTIR-spectrometer from Perkin Elmer (Lambda 900 [190-3000 nm] or System 2000 [1000-5000 nm]). The selection is determined by the required measuring range.

For measuring the absolute transmission, the sample bodies are polished on parallel planes (surface roughness RMS <0.5 nm) and the surface is cleared off all residues by ultrasound treatment. The sample thickness is 1 cm. In the case of an expected strong transmission loss due to impurities, dopants etc., a thicker or thinner sample can be selected in order to stay within the measuring range of the device. A sample thickness (measuring length) is selected at which only slight artefacts are produced on account of the passage of the radiation through the sample and at the same time a sufficiently detectable effect is measured.

The measurement of the opacity, the sample is placed in front of an integrating sphere. The opacity is calculated using the measured transmission value T according to the formula: O=1/T=I₀/I.

j. Refractive Index and Distribution of Refractive Index in a Tube or Rod

The distribution of refractive index of tubes/rods can be characterised by means of a York Technology Ltd. Preform Profiler P102 or P104. For this, the rod is placed lying in the measuring chamber the chamber is closed tight. The measuring chamber is then filled with an immersion oil which has a refractive index at the test wavelength of 633 nm which is very similar to that of the outermost glass layer at 633 nm. The laser beam then goes through the measuring chamber. Behind the measuring chamber (in the direction of the radiation) is mounted a detector which measures the angle of deviation (of the radiation entering the measuring chamber compared to the radiation exiting the measuring chamber). Under the assumption of radial symmetry of the distribution of refractive index of the rod, the diametral distribution of refractive index can be reconstructed by means of an inverse Abel transformation. These calculations are performed by the software of the device manufacturer York.

The refractive index of a sample is measured with the York Technology Ltd. Preform Profiler P104 analogue to the above description. In the case of isotropic samples, measurement of distribution of refractive index gives only one value, the refractive index.

k. Carbon Content

The quantitative measurement of the surface carbon content of silicon dioxide granulate and silicon dioxide powder is performed with a carbon analyser RC612 from Leco Corporation, USA, by the complete oxidation of all surface carbon contamination (apart from SiC) with oxygen to obtain carbon dioxide. For this, 4.0 g of a sample are weighed and introduced into the carbon analyser in a quartz glass boat. The sample is bathed in pure oxygen and heated for 180 seconds to 900° C. The CO₂ which forms is measured by the infrared detector of the carbon analyser. Under these measuring conditions, the detection limit lies at <1 ppm (weight-ppm) carbon.

A quartz glass boat which is suitable for this analysis using the above named carbon analyser is obtainable as a consumable for the LECO analyser with LECO number 781-335 on the laboratory supplies market, in the present case from Deslis Laborhandel, Flurstraße 21, D-40235 Dusseldorf (Germany), Deslis-No. LQ-130XL. Such a boat has width/length/height dimensions of ca. 25 mm/60 mm/15 mm. The quartz glass boat is filled up to half its height with sample material. For silicon dioxide powder, a sample weight of 1.0 g sample material can be reached. The lower detection limit is then <1 weight ppm carbon. In the same boat, a sample weight of 4 g of a silicon dioxide granulate is reached for the same filling height (mean particle size in the range from 100 to 500 μm). The lower detection limit is then about 0.1 weight ppm carbon. The lower detection limit is reached when the measurement surface integral of the sample is not greater than three times the measurement surface integral of an empty sample (empty sample=the above process but with an empty quartz glass boat).

l. Curl Parameter

The curl parameter (also called: “Fibre Curl”) is measured according to DIN EN 60793-1-34:2007-01 (German version of the standard IEC 60793-1-34:2006). The measurement is made according to the method described in Annex A in the sections A.2.1, A.3.2 and A.4.1 (“extrema technique”).

m. Attenuation

The attenuation is measured according to DIN EN 60793-1-40:2001 (German version of the standard IEC 60793-1-40:2001). The measurement is made according to the method described in the annex (“cut-back method”) at a wavelength of λ=1550 nm.

n. Viscosity of the Slurry

The slurry is set to a concentration of 30 weight-% solids content with demineralised water (Direct-Q 3UV, Millipore, Water quality: 18.2 MΩcm). The viscosity is then measured with a MCR102 from Anton-Paar. For this, the viscosity is measured at 5 rpm. The measurement is made at a temperature of 23° C. and an air pressure of 1013 hPa.

o. Thixotropy

The concentration of the slurry is set to a concentration of 30 weight-% of solids with demineralised water (Direct-Q 3UV, Millipore, water quality: 18.2 MΩcm). The thixotropy is then measured with an MCR102 from Anton-Paar with a cone and plate arrangement. The viscosity is measured at 5 rpm and at 50 rpm. The quotient of the first and the second value gives the thixotropic index. The measurement is made at a temperature of 23° C.

p. Zeta Potential of the Slurry

For zeta potential measurements, a zeta potential cell (Flow Cell, Beckman Coulter) is employed. The sample is dissolved in demineralised water (Direct-Q 3UV, Millipore, water quality: 18.2 MΩcm) to obtain a 20 mL solution with a concentration of 1 g/L. The pH is set to 7 through addition of HNO₃ solutions with concentrations of 0.1 mol/L and 1 mol/L and an NaOH solution with a concentration of 0.1 mol/L. The measurement is made at a temperature of 23° C.

q. Isoelectric Point of the Slurry

The isoelectric point, a zeta potential measurement cell (Flow Cell, Beckman Coulter) and an auto titrator (DelsaNano AT, Beckman Coulter) is employed. The sample is dissolved in demineralised water (Direct-Q 3UV, Millipore, water quality: 18.2 MΩcm) to obtain a 20 mL solution with a concentration of 1 g/L. The pH is varied by adding HNO₃ solutions with concentrations of 0.1 mol/L and 1 mol/L and an NaOH solution with a concentration of 0.1 mol/L. The isoelectric point is the pH value at which the zeta potential is equal to 0. The measurement is made at a temperature of 23° C.

### r. pH Value of the Slurry

The pH value of the slurry is measured using a WTW 3210 from Wissenschaftlich-Technische-Werkstitten GmbH. The pH 3210 Set 3 from WTW is employed as electrode. The measurement is made at a temperature of 23° C.

s. Solids Content

A weighed portion m₁ of a sample is heated for 4 hours to 500° C. reweighed after cooling (m₂). The solids content w is given as m₂/m₁*100 [Wt. %].

t. Bulk Density

The bulk density is measured according to the standard DIN ISO 697:1984-01 with an SMG 697 from Powtec.

The bulk material (silicon dioxide powder or granulate) does not clump.

u. Tamped Density (Granulate)

The tamped density is measured according to the standard DIN ISO 787:1995-10.

v. Measurement of the Pore Size Distribution

The pore size distribution is measured according to DIN 66133 (with a surface tension of 480 mN/m and a contact angle of 140°). For the measurement of pore sizes smaller than 3.7 nm, the Pascal 400 from Porotec is used. For the measurement of pore sizes from 3.7 nm to 100 μm, the Pascal 140 from Porotec is used. The sample is subjected to a pressure treatment prior to the measurement. For this a manual hydraulic press is used (Order-No. 15011 from Specac Ltd., River House, 97 Cray Avenue, Orpington, Kent BR5 4HE, U.K.). 250 mg of sample material is weighed into a pellet die with 13 mm inner diameter from Specac Ltd. and loaded with 1 t, as per the display. This load is maintained for 5 s and readjusted if necessary. The load on the sample is then released and the sample is dried for 4 h at 105±2° C. in a recirculating air drying cabinet.

The sample is weighed into the penetrometer of type 10 with an accuracy of 0.001 g and in order to give a good reproducibility of the measurement it is selected such that the stem volume used, i.e. the percentage of potentially used Hg volume for filling the penetrometer is in the range between 20% to 40% of the total Hg volume. The penetrometer is then slowly evacuated to 50 μm Hg and left at this pressure for 5 min. The following parameters are provided directly by the software of the measuring device: total pore volume, total pore surface area (assuming cylindrical pores), average pore radius, modal pore radius (most frequently occurring pore radius), peak n. 2 pore radius (μm).

w. Primary Particle Size

The primary particle size is measured using a scanning electron microscope (SEM) model Zeiss Ultra 55. The sample is suspended in demineralised water (Direct-Q 3UV, Millipore, water quality: 18.2 MΩcm), to obtain an extremely dilute suspension. The suspension is treated for 1 min with the ultrasound probe (UW 2070, Bandelin electronic, 70 W, 20 kHz) and then applied to a carbon adhesive pad.

x. Mean Particle Size in Suspension

The mean particle size in suspension is measured using a Mastersizer 2000, available from Malvern Instruments Ltd., UK, according to the user manual, using the laser deflection method. The sample is suspended in demineralised water (Direct-Q 3UV, Millipore, water quality: 18.2 MΩcm) to obtain a 20 mL suspension with a concentration of 1 g/L. The suspension is treated with the ultrasound probe (UW 2070, Bandelin electronic, 70 W, 20 kHz) for 1 min.

y. Particle Size and Core Size of the Solid

The particle size and core size of the solid are measured using a Camsizer XT, available from Retsch Technology GmbH, Germany according to the user manual. The software gives the D10, D50 and D90 values for a sample.

z. BET Measurement

For the measurement of the specific surface area, the static volumetric BET method according to DIN ISO 9277:2010 is used. For the BET measurement, a “NOVA 3000” or a “Quadrasorb” (available from Quantachrome), which operate according to the SMART method (“Sorption Method with Adaptive dosing Rate”), is used. The micropore analysis is performed using the t-plot process (p/p0=0.1-0.3) and the mesopore analysis is performed using the MBET process (p/p0=0.0-0.3). As reference material, the standards alumina SARM-13 and SARM-214, available from Quantachrome are used. The tare weight of the measuring cell (clean and dry) is weighed. The type of measuring cell is selected such that the sample material which is introduced and the filler rod fill the measuring cell as much as possible and the dead space is reduced to a minimum. The sample material is introduced into the measuring cell. The amount of sample material is selected so that the expected value of the measurement value corresponds to 10-20 m²/g. The measuring cells are fixed in the baking positions of the BET measuring device (without filler rod) and evacuated to <200 mbar. The speed of the evacuation is set so that no material leaks from the measuring cell. Baking is performed in this state at 200° C. for 1 h. After cooling, the measuring cell filled with the sample is weighed (raw value). The tare weight is then subtracted from the raw value of the weight=nett weight=weight of the sample. The filling rod is then introduced into the measuring cell this is again fixed at the measuring location of the BET measuring device. Prior to the start of the measurement, the sample identifications and the sample weights are entered into the software. The measurement is started. The saturation pressure of nitrogen gas (N2 4.0) is measured. The measuring cell is evacuated and cooled down to 77 K using a nitrogen bath. The dead space is measured using helium gas (He 4.6). The measuring cell is evacuated again. A multi point analysis with at least 5 measuring points is performed. N2 4.0 is used as absorptive. The specific surface area is given in m²/g.

za. Viscosity of Glass Bodies

The viscosity of the glass is measured using the beam bending viscosimeter of type 401—from TA Instruments with the manufacturer's software WinTA (current version 9.0) in Windows 10 according to the DIN ISO 7884-4:1998-02 standard. The support width between the supports is 45 mm. Sample rods with rectangular cross section are cut from regions of homogeneous material (top and bottom sides of the sample have a finish of at least 1000 grain). The sample surfaces after processing have a grain size=9 μm & RA=0.15 μm. The sample rods have the following dimensions: length=50 mm, width=5 mm & height=3 mm (ordered: length, width, height, as in the standards document). Three samples are measured and the mean is calculated. The sample temperature is measured using a thermocouple tight against the sample surface. The following parameters are used: heating rate=25 K up to a maximum of 1500° C., loading weight=100 g, maximum bending=3000 μm (deviation from the standards document).

zc. Residual Moisture (Water Content)

The measurement of the residual moisture of a sample of silicon dioxide granulate is performed using a Moisture Analyzer HX204 from Mettler Toledo. The device functions using the principle of thermogravimetry. The HX204 is equipped with a halogen light source as heating element. The drying temperature is 220° C. The starting weight of the sample is 10 g±10%. The “Standard” measuring method is selected. The drying is carried out until the weight change reaches not more than 1 mg/140 s. The residual moisture is given as the difference between the initial weight of the sample and the final weight of the sample, divided by the initial weight of the sample. The measurement of residual moisture of silicon dioxide powder is performed according to DIN EN ISO 787-2:1995 (2 h, 105° C.).

### Examples

The example is further illustrated in the following through examples. The invention is not limited by the examples.

### A. 1. Preparation of Silicon Dioxide Powder (OMCTS Route)

An aerosol formed by atomising a siloxane with air (A) is introduced under pressure into a flame which is formed by igniting a mixture of oxygen enriched air (B) and hydrogen. Furthermore, a gas flow (C) surrounding the flame is introduced and the process mixture is then cooled with process gas. The product is separated off at a filter. The process parameters are given in table 1 and the specifications of the resulting product are given in table 2. Experimental data for this example are indicated with A1-x.

### 2. Modification 1: Increased Carbon Content

A process was carried out as described in A.1., but the burning of the siloxane was performed in such a way that an amount of carbon was also formed. Experimental data for this example are indicated with A2-x.

TABLE 1

| Example | | A1-1 | A2-1 | A2-2 |
|---|---|---|---|---|
| Aerosol formation | | | | |
| Siloxane | | OMCTS* | OMCTS* | OMCTS* |
| Feed rate | kg/h | 10 | 10 | 10 |
| | (kmol/h) | (0.0337) | (0.0337) | (0.0337) |
| Feed rate of air (A) | Nm³/h | 14 | 10 | 12 |
| Pressure | barO | 1.2 | 1.2 | 1.2 |
| Burner feed | | | | |
| Oxygen enriched air (B) | Nm³/h | 69 | 65 | 68 |
| O₂-content | Vol. % | 32 | 30 | 32 |
| total O₂ feed rate | Nm³/h | 25.3 | 21.6 | 24.3 |
| | kmol/h | 1.130 | 0.964 | 1.083 |
| Hydrogen feed rate | Nm³/h | 27 | 27 | 12 |
| | kmol/h | 1.205 | 1.205 | 0.536 |
| Feed | | — | — | |
| Carbon compound | | | | |
| Material | | | | methane |
| Amount | Nm³/h | | | 5.5 |
| Air flow (C) | Nm³/h | 60 | 60 | 60 |

| | | | |
|---|---|---|---|
| Stoichiometric ratio | | | |
| V | 2.099 | 1.789 | 2.011 |
| X | 0.938 | 0.80 | 2.023 |
| Y | 0.991 | 0.845 | 0.835 |

V = molar ratio of employed O₂/O₂ required for completed oxidation of the siloxane;
X = molar ratio O₂/H₂;
Y = (molar ratio of employed O₂/O₂ required for stoichiometric conversion OMCTS + fuel gas);
barO = over pressure;
*OMCTS = Octamethylcyclotetrasiloxane.

TABLE 2

| Example | | A1-1 | A2-1 | A2-2 |
|---|---|---|---|---|
| BET | m²/g | 30 | 33 | 34 |
| Bulk density | g/ml | 0.114 +− 0.011 | 0.105 +− 0.011 | 0.103 +− 0.011 |
| tamped density | g/ml | 0.192 +− 0.015 | 0.178 +− 0.015 | 0.175 +− 0.015 |
| Primary particle size | nm | 94 | 82 | 78 |
| particle size distribution D10 | μm | 3.978 ± 0.380 | 5.137 ± 0.520 | 4.973 ± 0.455 |
| particle size distribution D50 | μm | 9.383 ± 0.686 | 9.561 ± 0.690 | 9.423 ± 0.662 |
| particle size distribution D90 | μm | 25.622 ± 1.387 | 17.362 ± 0.921 | 18.722 ± 1.218 |
| C content | ppm | 34 ± 4 | 73 ± 6 | 80 ± 6 |
| Cl content | ppm | <60 | <60 | <60 |
| Al content | ppb | 20 | 20 | 20 |
| Total content of metals other than Al | ppb | <700 | <700 | <700 |
| residual moisture content | wt.-% | 0.02-1.0 | 0.02-1.0 | 0.02-1.0 |
| pH value in water 4% (IEP) | — | 4.8 | 4.6 | 4.5 |
| Viscosity at 5 rpm, aqueous | mPas | 753 | 1262 | 1380 |
| suspension 30 Wt-%, 23° C. | | | | |
| Alkali earth metal content | ppb | 538 | 487 | 472 |

B. 1. Preparation of Silicon Dioxide Powder (Silicon Source: SiCl₄) A portion of silicon tetrachloride (SiCl₄) is evaporated at a temperature T and introduced with a pressure P into a flame of a burner which is formed by igniting a mixture of oxygen enriched air and hydrogen. The mean normalised gas flow to the outlet is held constant. The process mixture is then cooled with process gas. The product was separated off at a filter. The process parameters are given in table 3 and the specifications of the resulting products are given in table 4. They are indicated with B1-x.

### 2. Modification: Increased Carbon Content

A process was carried out as described in B.1., but the burning of the silicon tetrachloride was performed such that an amount of carbon was also formed. Experimental data for this example are indicated with B2-x.

TABLE 3

| Example | | B1-1 | B2-1 |
|---|---|---|---|
| Aerosol formation | | | |
| Silicon tetrachloride feed | kg/h | 50 | 50 |
| | (kmol) | (0.294) | (0.294) |
| Temperature T | ° C. | 90 | 90 |
| Pressure p | barO | 1.2 | 1.2 |
| Burner feed | | | |
| Oxygen enriched air, | Nm³/h | 145 | 115 |
| O₂ content therein | Vol. % | 45 | 30 |
| Feed | | — | |
| Carbon compound | | | |
| Material | | | methane |
| Amount | Nm³/h | | 2.0 |
| Hydrogen feed | Nm³/h | 115 | 60 |
| | kmol/h | 5.13 | 2.678 |

| | | |
|---|---|---|
| Stoichiometric ratios | | |
| X | 0.567 | 0.575 |
| Y | 0.946 | 0.85 |

X = as molar ratio O₂/H₂; Y = molar ratio of employed O₂/O₂ required for stoichiometric reaction with SiCl₄ + H₂ + CH₄); barO = Over pressure.

TABLE 4

| Example | | B1-1 | B2-1 |
|---|---|---|---|
| BET | m²/g | 49 | 47 |
| Bulk density | g/ml | 0.07 ± 0.01 | 0.06 ± 0.01 |
| tamped density | g/ml | 0.11 ± 0.01 | 0.10 ± 0.01 |
| Primary particle size | nm | 48 | 43 |
| particle size distribution D10 | μm | 5.0 ± 0.5 | 4.5 ± 0.5 |
| particle size distribution D50 | μm | 9.3 ± 0.6 | 8.7 ± 0.6 |
| particle size distribution D90 | μm | 16.4 ± 0.5 | 15.8 ± 0.7 |
| C content | ppm | <4 | 76 |
| Cl content | ppm | 280 | 330 |
| Al content | ppb | 20 | 20 |
| Total of the concentrations of | ppb | <1300 | <1300 |
| Ca, Co, Cr, Cu, Fe, Ge, Hf, K, | | | |
| Li, Mg, Mn, Mo, Na, Nb, Ni, Ti, | | | |
| V, W, Zn, Zr | | | |
| residual moisture content | wt.-% | 0.02-1.0 | 0.02-1.0 |
| pH value in water 4% (IEP) | pH | 3.8 | 3.8 |
| Viscosity at 5 rpm, aqueous | mPas | 5653 | 6012 |
| suspension 30 Wt-%, 23° C. | | | |
| Alkali earth metal content | ppb | 550 | 342 |

### C. Steam Treatment

A particle flow of silicon dioxide powder is introduced via the top of a standing column. Steam at a temperature (A) and air are fed via the bottom of the column. The column is maintained at a temperature (B) at the top of the column and at a second temperature (C) at the bottom of the column by an internally situated heater. After leaving the column (holding time (D)) the silicon dioxide powder has in particular the properties shown in Table 6. The process parameters are given in Table 5.

TABLE 5

| Example | | C-1 | C-2 |
|---|---|---|---|
| Educt: Product of | | B1-1 | B2-1 |
| Educt feed | kg/h | 100 | 100 |
| Steam feed | kg/h | 5 | 5 |
| Steam temperature (A) | ° C. | 120 | 120 |
| Air feed | Nm³/h | 4.5 | 4.5 |
| Column | | | |
| height | m | 2 | 2 |
| Inner diameter | mm | 600 | 600 |
| T (B) | ° C. | 260 | 260 |
| T (C) | ° C. | 425 | 425 |
| Holding time (D) silicon | s | 10 | 10 |
| dioxide powder | | | |

TABLE 6

| Example | | C-1 | C-2 |
|---|---|---|---|
| pH value in water 4% (IEP) | — | 4.6 | 4.6 |
| Cl content | ppm | <60 | <60 |
| C content | ppm | <4 | 36 |
| Viscosity at 5 rpm, aqueous | mPas | 1523 | 1478 |
| suspension 30 Wt-%, 23° C. | | | |

The silicon dioxide powders obtained in the examples C-1 and C-2 each have a low chlorine content as well as a moderate pH value in suspension. The carbon content of example C-2 is higher than for C-1.

D. Treatment with a Neutralising Agent

A particle flow of silicon dioxide powder is introduced via the top of a standing column. A neutralising agent and air are fed via the bottom of the column. The column is maintained at a temperature (B) at the top of the column and at a second temperature (C) at the bottom of the column by an internally situated heater. After leaving the column (holding time (D)) the silicon dioxide powder has in particular the properties shown in table 8. The process parameters are given in table 7.

TABLE 7

| Example | | D-1 |
|---|---|---|
| Educt: Product from | | B1-1 |
| Educt feed | kg/h | 100 |
| Neutralising agent | | Ammonia |
| Neutralising agent feed | kg/h | 1.5 |
| Neutralising agent | | Obtainable from Air Liquide: |
| specifications | | Ammonia N38, purity ≥99.98 Vol. % |
| Air feed | Nm³/h | 4.5 |
| Column | | |
| height | m | 2 |
| inner diameter | mm | 600 |
| T (B) | ° C. | 200 |
| T (C) | ° C. | 250 |
| Holding time (D) of | s | 10 |
| silicon dioxide powder | | |

TABLE 8

| Example | | D-1 |
|---|---|---|
| pH value in water 4% (IEP) | — | 4.8 |
| Cl content | ppm | 210 |
| C content | ppm | <4 |
| Viscosity at 5 rpm, aqueous | mPas | 821 |
| suspension 30 Wt-%, 23° C. | | |

E. 1. Preparation of Silicon Dioxide Granulate from Silicon Dioxide Powder

A silicon dioxide powder is dispersed in fully desalinated water. For this, an intensive mixer of type R from the Gustav Eirich machine factory is used. The resulting suspensions are pumped with a membrane pump and thereby pressurised and converted into droplets by a nozzle. These are dried in a spray tower and collect on the floor of the tower. The process parameters are given in Table 9 and the properties of the obtained granulate in Table 10. Experimental data for this example are indicated with E1-x. In E2-21 to E2-23, aluminium oxide is introduced as additive. In E2-31 and E2-32

### 2. Modification: Increased Carbon Content

The process is analogous to that described in E.1. Additionally, carbon powder is dispersed into the suspension as additive. Experimental data for these examples are indicated with E2-x.

TABLE 9

| | | Example | | | | | | | | |
|---|---|---|---|---|---|---|---|---|---|---|
| | | E1-1 | E1-2 | E1-3 | E1-4 | E1-5 | E2-1 | E2-21 | E2-22 | E2-23 |
| Educt = Product | | A1-1 | A2-1 | B1-1 | C-1 | C-2 | A1-1 | A1-1 | A1-1 | A1-1 |
| from | | | | | | | | | | |
| Amount of educt | Kg | 10 | 10 | 10 | 10 | 10 | 10 | 1000 | 1000 | 1000 |
| Additive | | — | — | — | — | — | | | | |
| Material | | | | | | | C** | Al₂O₃⁺ | Al₂O₃⁺ | Al₂O₃⁺ |
| Max. Particle | | | | | | | 75 μm | 65 μm | 65 μm | 65 μm |
| size | | | | | | | | | | |
| Amount | | | | | | | 1 g | 0.32 g | 0.47 g | 0.94 g |
| Water | Rating* | FD | FD | FD | FD | FD | FD | FD | FD | FD |
| | Litre | 5.4 | 5.4 | 5.4 | 5.4 | 5.4 | 5.4 | 5.4 | 5.4 | 5.4 |
| Dispersion | | | | | | | | | | |
| Solids content | Wt. % | 65 | 65 | 65 | 65 | 65 | 65 | 65 | 65 | 65 |
| Nozzle | | | | | | | | | | |
| Diameter | mm | 2.2 | 2.2 | 2.2 | 2.2 | 2.2 | 2.2 | 2.2 | 2.2 | 2.2 |
| Temperature | ° C. | 25 | 25 | 25 | 25 | 25 | 25 | 25 | 25 | 25 |
| Pressure | Bar | 16 | 16 | 16 | 16 | 16 | 16 | 16 | 16 | 16 |
| Installation | m | 6.5 | 6.5 | 6.5 | 6.5 | 6.5 | 6.5 | 6.5 | 6.5 | 6.5 |
| height | | | | | | | | | | |
| Spray tower | | | | | | | | | | |
| Height | m | 18.20 | 18.20 | 18.20 | 18.20 | 18.20 | 18.20 | 18.20 | 18.20 | 18.20 |
| Inner diameter | m | 6.30 | 6.30 | 6.30 | 6.30 | 6.30 | 6.30 | 6.30 | 6.30 | 6.30 |
| T (introduced | ° C. | 380 | 380 | 380 | 380 | 380 | 380 | 380 | 380 | 380 |
| gas) | | | | | | | | | | |
| T (exhaust) | ° C. | 110 | 110 | 110 | 110 | 110 | 110 | 110 | 110 | 110 |
| Air flow | m³/h | 6500 | 6500 | 6500 | 6500 | 6500 | 6500 | 6500 | 6500 | 6500 |

Installation height = distance between nozzle and lowest point of the spray tower interior in the direction of gravity.
*FD = fully desalinated, conductance ≤ 0.1 μS;
**C 006011: Graphite powder, max. particle size: 75 μm, high purity (available from Goodfellow GmbH, Bad Nauheim (Germany).
⁺Aeroxide Alu 65: highly dispersed pyrogenic aluminium oxide, particle size 65 μm (Evonik Industries AG, Essen (Germany)

TABLE 10

| | | Example | | | | | | | | |
|---|---|---|---|---|---|---|---|---|---|---|
| | | E1-1 | E1-2 | E1-3 | E1-4 | E1-5 | E2-1 | E2-21 | E2-22 | E2-23 |
| BET | m²/g | 30 | 33 | 49 | 49 | 47 | 28 | 32 | 30 | 32 |
| Bulk density | g/ml | 0.8 ± 0.1 | 0.8 ± 0.1 | 0.8 ± 0.1 | 0.8 ± 0.1 | 0.8 ± 0.1 | 0.8 ± 0.1 | 0.8 ± 0.1 | 0.8 ± 0.1 | 0.8 ± 0.1 |
| tamped density | g/ml | 0.9 ± 0.1 | 0.9 ± 0.1 | 0.9 ± 0.1 | 0.9 ± 0.1 | 0.9 ± 0.1 | 0.9 ± 0.1 | 0.9 ± 0.1 | 0.9 ± 0.1 | 0.9 ± 0.1 |
| mean particle | μm | 255 | 255 | 255 | 255 | 255 | 255 | 255 | 255 | 255 |
| size | | | | | | | | | | |
| particle size | μm | 110 | 110 | 110 | 110 | 110 | 110 | 110 | 110 | 110 |
| distribution | | | | | | | | | | |
| D10 | | | | | | | | | | |
| particle size | μm | 222 | 222 | 222 | 222 | 222 | 222 | 222 | 222 | 222 |
| distribution | | | | | | | | | | |
| D50 | | | | | | | | | | |
| particle size | μm | 390 | 390 | 390 | 390 | 390 | 390 | 390 | 390 | 390 |
| distribution | | | | | | | | | | |
| D90 | | | | | | | | | | |
| SPHT3 | Dimless | 0.64-0.98 | 0.64-0.98 | 0.64-0.98 | 0.64-0.98 | 0.64-0.98 | 0.64-0.98 | 0.64-0.98 | 0.64-0.98 | 0.64-0.98 |
| Aspect ratio | Dimless | 0.64-0.94 | 0.64-0.94 | 0.64-0.94 | 0.64-0.94 | 0.64-0.94 | 0.64-0.94 | 0.64-0.94 | 0.64-0.94 | 0.64-0.94 |
| W/L (width to | | | | | | | | | | |
| length) | | | | | | | | | | |
| C content | ppm | <4 | 39 | <4 | <4 | 32 | 100 | <4 | <4 | <4 |
| Cl content | ppm | <60 | <60 | 280 | <60 | <60 | <60 | <60 | <60 | <60 |
| Al content | ppb | 20 | 20 | 20 | 20 | 20 | 20 | 190 | 270 | 520 |
| Total of the | ppb | <700 | <700 | <1300 | <1300 | <1300 | <700 | <700 | <700 | <700 |
| concentrations | | | | | | | | | | |
| of Ca, Co, Cr, | | | | | | | | | | |
| Cu, Fe, Ge, Hf, | | | | | | | | | | |
| K, Li, Mg, Mn, | | | | | | | | | | |
| Mo, Na, Nb, | | | | | | | | | | |
| Ni, Ti, V, W, | | | | | | | | | | |
| Zn, Zr | | | | | | | | | | |
| residual moisture | wt.-% | <3 | <3 | <3 | <3 | <3 | <3 | <3 | <3 | <3 |
| content | | | | | | | | | | |
| Alkaline earth | ppb | 538 | 487 | 550 | 550 | 342 | 538 | 517 | 490 | 541 |
| metal content | | | | | | | | | | |
| pore volume | ml/g | 0.33 | 0.33 | 0.45 | 0.45 | 0.45 | 0.33 | 0.33 | 0.33 | 0.33 |
| angle of repose | ° | 26 | 26 | 26 | 26 | 26 | 26 | 26 | 26 | 26 |

The granulates are all open pored, have a uniform and spherical shape (all by microscopic investigation). They tend not to stick together or cement.

### F. Cleaning of Silicon Dioxide Granulate

Silicon dioxide granulate is first optionally treated with oxygen at a temperature T1 in a rotary kiln. Subsequently, the silicon dioxide granulate is treated with a co-flow of chlorine-containing components, wherein the temperature is raised to a temperature T2. The process parameters are given in Table 11 and the properties of the obtained treated granulate in Table 12.

TABLE 11

| | | Example | | | | | |
|---|---|---|---|---|---|---|---|
| | | F1-1 | F1-2 | F2-1 | F2-21 | F2-22 | F2-23 |
| Educt = Product from | | E1-1 | E1-2 | E2-1 | E2-21 | E2-22 | E2-23 |
| Rotary kiln¹⁾ | | | | | | | |
| length | cm | 200 | | | 200 | 200 | 200 |
| Inner diameter | cm | 10 | | | 10 | 10 | 10 |
| Throughput | kg/h | 2 | | | 2 | 2 | 2 |
| Rotational speed | rpm | 2 | | | 2 | 2 | 2 |
| T1 | ° C. | 1100 | NA | NA | 1100 | 1100 | 1100 |
| Atmosphere | | O₂ pur | NA | NA | O₂ pure | O₂ pure | O₂ pure |
| Reactant | | O₂ | NA | NA | O₂ | O₂ | O₂ |
| Feed | | 300 l/h | NA | NA | 300 l/h | 300 l/h | 300 l/h |
| residual moisture content | wt.-% | <1 | <3 | <3 | <1 | <1 | <1 |
| T2 | ° C. | 1100 | 1100 | 1100 | 1100 | 1100 | 1100 |
| Co-flow | | | | | | | |
| Component 1: HCl | l/h | 50 | 50 | 50 | 50 | 50 | 50 |
| Component 2: Cl2 | l/h | 0 | 15 | 15 | 0 | 0 | 0 |
| Component 3: N2 | l/h | 50 | 35 | 35 | 50 | 50 | 50 |
| Total co-flow | l/h | 100 | 100 | 100 | 100 | 100 | 100 |

¹⁾For the rotary kilns, the throughput is selected as the control variable. That means that during operation the mass flow exiting from the rotary kiln is weighed and then the rotational speed and/or the inclination of the rotary kiln is adapted accordingly. For example, an increase in the throughput can be achieved by a) increasing the rotational speed, or b) increasing the inclination of the rotary kiln away from horizontal, or a combination of a) and b).

TABLE 12

| | | Example | | | | | |
|---|---|---|---|---|---|---|---|
| | | F1-1 | F1-2 | F2-1 | F2-21 | F2-22 | F2-23 |
| BET | m²/g | 25 | 27 | 23 | 26 | 26 | 23 |
| C content | ppm | <4 | <4 | <4 | <4 | <4 | <4 |
| Cl content | ppm | 100-200 | 100-200 | 100-200 | 100-200 | 100-200 | 100-200 |
| Al content | ppb | 20 | 20 | 20 | 190 | 270 | 520 |
| Pore volume | mm³/g | 650 | 650 | 650 | 650 | 650 | 650 |
| Total of the concentrations of | ppb | <200 | <200 | <200 | <200 | <200 | <200 |
| Ca, Co, Cr, Cu, Fe, Ge, Hf, K, | | | | | | | |
| Li, Mg, Mn, Mo, Na, Nb, Ni, | | | | | | | |
| Ti, V, W, Zn, Zr | | | | | | | |
| Alkaline earth metal content | ppb | 115 | 55 | 35 | 124 | 110 | 116 |
| tamped density | g/cm³ | 0.95 ± 0.05 | 0.95 ± 0.05 | 0.95 ± 0.05 | 0.95 ± 0.05 | 0.95 ± 0.05 | 0.95 ± 0.05 |

In the case of F1-2 and F2-1, the granulates after the cleaning step show a significantly reduced carbon content (like low carbon granulates, e.g. F1-1) and a significantly reduced content of alkaline earth metals. SiC formation was not observed.

### G. Making a Glass Body

Silicon dioxide granulate according to line 2 of Table 13 was used as raw material. A graphite mould was prepared with an annular hollow space and an outer diameter of the formed body of dₐ, an inner diameter of the formed body of d₁ and a length l. A high-purity graphite foil having a thickness of 1 mm was applied on to the inner wall of the outer formed body and a graphite foil composed of the same high-purity graphite having a thickness of 1 mm was applied on to the outer wall of the inner formed body. A high-purity graphite web composed of a high-purity graphite having a bulk density of 1.2 g/cm³ and a thickness of 0.4 mm was applied on to the base of the annular hollow space of the mould (in the case of G-2: cylindrical hollow space). The high-purity graphite mould provided with the graphite foil was filled with the silicon dioxide granulate. The filled graphite mould was introduced into an oven to which a vacuum was applied. The filled silicon dioxide granulate was brought from the temperature T1 at a rate of heating R1 to a temperature T2 and held at this temperature for the period t2. Then, it was warmed at the rate of heating R2 to T3, and then, without any further tempering, brought at the rate of heating R3 to the temperature T4, and further at the rate of heating R4 to the temperature T5 and held at this temperature for the period t5. During the last 240 minutes, a pressure of 1.6*10⁶ Pa nitrogen is applied to the oven. Afterwards, the mould is gradually cooled. When a temperature of 1050° C. was reached, the mould was held at this temperature for a period of 240 min. Subsequently, it was further cooled gradually to T6. The process parameters are compiled in Table 13, the properties of the quartz glass body that was made in Table 14. “Gradual cooling” means that the mould is left to stand in the switched off oven without any cooling measures, i.e. is cooled only by emission of heat to the environment.

TABLE 13

| | | Example | | | | | |
|---|---|---|---|---|---|---|---|
| | | G1-1 | G1-2 | G2-1 | G2-21 | G2-22 | G2-23 |
| Educt = | | F1-1 | F1-2 | F2-1 | F2-21 | F2-22 | F2-23 |
| Product | | | | | | | |
| from | | | | | | | |
| T1 | ° C. | 25 | 25 | 25 | 25 | 25 | 25 |
| R1 | ° C./min | +2 | +2 | +2 | +2 | +2 | +2 |
| T2 | ° C. | 400 | 400 | 400 | 400 | 400 | 400 |
| t2 | min | 60 | 60 | 60 | 60 | 60 | 60 |
| R2 | ° C./min | +3 | +3 | +3 | +3 | +3 | +3 |
| T3 | ° C. | 1000 | 1000 | 1000 | 1000 | 1000 | 1000 |
| R3 | ° C./min | +0.2 | +0.2 | +0.2 | +0.2 | +0.2 | +0.2 |
| T4 | ° C. | 1350 | 1350 | 1350 | 1350 | 1350 | 1350 |
| R4 | ° C./min | +2 | +2 | +2 | +2 | +2 | +2 |
| T5 | ° C. | 1750 | 1750 | 1750 | 1750 | 1750 | 1750 |
| t5 | min | 720 | 720 | 720 | 720 | 720 | 720 |
| T6 | ° C. | 25 | 25 | 25 | 25° C. | 25° C. | 25° C. |

TABLE 14

| | | Example | | | | | |
|---|---|---|---|---|---|---|---|
| | | G1-1 | G1-2 | G2-1 | G2-21 | G2-22 | G2-23 |
| Length (quartz glass | mm | 2000 | 1000 | 2000 | 2000 | 2000 | 2000 |
| body) | | | | | | | |
| Outer diameter (quartz | mm | 260 | 560 | 260 | 260 | 260 | 260 |
| glass body) | | | | | | | |
| Inner diameter (quartz | mm | 45 | — | 45 | 45 | 45 | 45 |
| glass body) | | | (solid) | | | | |
| OH content* | ppm | 0.3 ± 0.2 | 0.4 ± 0.2 | 0.4 ± 0.2 | 0.3 ± 0.2 | 0.3 ± 0.2 | 0.3 ± 0.2 |
| C content | ppm | <4 | <4 | <4 | <4 | <4 | <4 |
| Cl content* | ppm | <60 | <60 | <60 | <60 | <60 | <60 |
| Al content* | ppb | 14 ± 5 | 13 ± 5 | 12 ± 5 | 185 ± 5 | 280 ± 5 | 510 ± 5 |
| ODC content | /cm3 | 0.8 * 10¹⁵ | 1.7 * 10¹⁵ | 1.1 * 10^{15x} | 0.8 * 10¹⁵ | 0.8 * 10¹⁵ | 0.8 * 10¹⁵ |
| Sum of concentrations | ppb | 153 | 62 | 171 | 160 | 166 | 172 |
| of Ca, Co, Cr, Cu, Fe, | | | | | | | |
| Ge, Hf, K, Li, Mg, Mn, | | | | | | | |
| Mo, Na, Nb, Ni, Ti, V, | | | | | | | |
| W, Zn, Zr | | | | | | | |
| Refractive index homogeneity | ppm | 30 | 30 | 30 | 30 | 30 | 30 |
| Fictive temperature | ° C. | 1109 | 1137 | 1148 | 1120 | 1113 | 1244 |
| Viscosity | Lg (/dpas) | | | | | | |
| @1250° C. | | 12.6 | 12.4 | 12.7 | 12.6 | 12.6 | 12.7 |
| @1300° C. | | 11.8 | 11.8 | 11.8 | 11.8 | 11.8 | 11.8 |
| @1350° C. | | 11.1 | 11.1 | 11.1 | 11.1 | 11.1 | 11.2 |

“±” data are the standard deviation
All glass bodies show very good values for OH, catbon and aluminium content

### H. Preparation of a Reactor

The quartz glass body produced in example G2-1 above is formed into a bell by glass blowing. Together with a lid (also composed of quartz glass, comprising feed-throughs), this forms a reaction chamber into which silicon wafers for semiconductor fabrication are introduced and then subjected to certain processes. The reaction chamber made out of the quartz glass prepared according to Example G had a significantly longer operating time (under comparable temperature conditions) than a conventional one. Moreover, better dimensional stability at high temperatures was observed.

### J. Preparation of a Large Tube

The glass bodies from example G1-1 and G2-x were shaped in the warm in two steps at a temperature of 2100° C. Variations in the material homogeneity lead in such a treatment to variations in the geometry of the shaped glass body. The general procedure for such a two stage shaping step is known and for example is described in DE 10 2013 107 434 A1, paragraph [0051]-[0065]. The glass body from example G1-1 and G2-x is referred to there as a hollow cylinder. The properties of the glass body shaped in a first step from example J1-1 and J2-x are presented in table 17, and the properties after the second shaping step in table 18.

TABLE 17

| | Example | | | | |
|---|---|---|---|---|---|
| | | J1-1 | J2-21 | J2-22 | J2-23 |
| | Material = Product from | | | | |
| | | G1-1 | G2-21 | G2-22 | G2-23 |
| 1st shaping step: | | | | | |
| Intermediate cylinder | | | | | |
| Outer diameter | mm | 320 | 320 | 320 | 320 |
| Wall thickness | | 15 | 15 | 15 | 15 |
| Length | | 6200 | 6200 | 6200 | 6200 |
| Al content | ppb | 14 ± 5 | 185 ± 5 | 280 ± 5 | 510 ± 5 |

TABLE 18

| | Example | | | | |
|---|---|---|---|---|---|
| | | K1-1 | K2-21 | K2-22 | K2-23 |
| | Material = Product from | | | | |
| | | J1-1 | J2-21 | J2-22 | J2-23 |
| 2nd Shaping step: | | | | | |
| Intermediate cylinder | | | | | |
| Outer diameter | mm | 960 | 960 | 960 | 960 |
| Wall thickness | | 15 | 15 | 15 | 15 |
| Length | | 2980 | 2980 | 2980 | 2980 |
| Al content | ppb | 14 ± 5 | 185 ± 5 | 280 ± 5 | 510 ± 5 |
| Wall thickness variation | mm/m | 0.31 | 0.39 | 0.56 | 1.1 |

The smaller the variation of the wall thickness, the better.

Measurement of the variation of the wall thickness: The sample body (Glass tube) is measured on a glass rotation bench. For this the sample body does not rotate. Parallel to the length axis of the sample body, an optical measuring head is run along the sample body and the wall thickness is recorded continuously as the separation of the measuring head from the outer surface of the sample body and captured as data. For the measuring head, a CHRocodile M4 from the company Precitec High Resolution was employed.

1-21. (canceled)

22. A process for the preparation of a quartz glass body comprising pyrogenic silicon dioxide, comprising:
providing a silicon dioxide granulate comprising:
providing a pyrogenic silicon dioxide powder; and
processing the silicon dioxide powder to obtain a silicon dioxide granulate, wherein the silicon dioxide granulate has a greater particle diameter than the silicon dioxide powder;
making a glass melt out of the silicon dioxide granulate in an oven;
making a quartz glass body out of at least part of the glass melt;
wherein the quartz glass body comprises:
an OH content of less than 10 ppm;
a chlorine content of less than 60 ppm; and
an aluminium content of less than 200 ppb;
wherein the ppb and ppm are each based on the total weight of the quartz glass body.

23. The process according to claim 22, wherein the pyrogenic silicon dioxide powder is present in the form of amorphous silicon dioxide particles, wherein the silicon dioxide powder comprises:
a chlorine content of less than 200 ppm; and
an aluminium content of less than 200 ppb;
wherein the silicon dioxide granulate is treated with a reactant.

24. The process according to claim 22, wherein the warming of the silicon dioxide granulate takes place to obtain a glass melt by a mould melting process.

25. The process according to claim 22, wherein during the warming, for a period t_{T}, a temperature T_{T} is maintained which is below the melting point of silicon dioxide.

26. The process according to claim 25, further comprising at least one of:
wherein the temperature T_{T} is in a range from 1000 to 1700° C.; and
wherein the period t_{T} is in a range from 1 to 6 hours.

27. The process according to claim 25, wherein the period t_{T} is before the making of the glass melt.

28. The process according to one claim 25, wherein the quartz glass body obtained is cooled at least to a temperature of 1000° C. at a rate of up to 5 K/min.

29. The process according to claim 25, wherein the cooling takes place in a temperature range from 1300 to 1000° C. at a rate of not more than 1 K/min.

30. The process according to claim 25, wherein the quartz glass body further comprises at least one of:
a fictive temperature in a range from 1055 to 1200° C.;
an ODC content of less than 5×10¹⁵/cm³;
a metal content of metals different to aluminium of less than 300 ppb;
a viscosity (p=1013 hPa) in a range from log₁₀ (η (1200° C.)/dPas)=13.4 to log₁₀ (η (1200° C.)/dPas)=13.9 or log₁₀ (η (1300° C.)/dPas)=11.5 to log₁₀ (η (1300° C.)/dPas)=12.1 or log₁₀ (η (1350° C.)/dPas)=1.2 to log₁₀ ((1350° C.)/dPas)=10.8;
a standard deviation of the OH content of not more than 10%, based on the OH content of the quartz glass body;
a standard deviation of the Cl content of not more than 10%, based on the Cl content of the quartz glass body;
a standard deviation of the Al content of not more than 10%, based on the Al content of the quartz glass body;
a refractive index homogeneity of less than 1×10⁻⁴; and
a transformation point Tg in a range from 1150 to 1250° C.;
wherein the ppb and ppm are each based on the total weight of the quartz glass body.

31. The process according to claim 25, wherein the silicon dioxide powder comprises at least one of:
a BET surface area in a range from 20 to 60 m²/g and;
a bulk density in a range from 0.01 to 0.3 g/cm³;
a carbon content of less than 50 ppm;
a chlorine content of less than 200 ppm;
an aluminium content of less than 200 ppb;
a total content of metals different to aluminium of less than 5 ppm;
at least 70 wt.-% of the powder particles have a primary particle size in a range from 10 to 100 nm;
a tamped density in a range from 0.001 to 0.3 g/cm³;
a residual moisture content of less than 5 wt.-%;
a particle size distribution D₁₀ in a range from 1 to 7 μm;
a particle size distribution D₅₀ in a range from 6 to 15 μm; and
a particle size distribution D90 in a range from 10 to 40 μm;
wherein the ppm and ppb are each based on the total weight of the silicon dioxide powder.

32. The process according to claim 25, wherein the silicon dioxide powder is prepared from a compound selected from the group consisting of siloxanes, silicon alkoxides and silicon halides.

33. The process according to claim 25, wherein the processing of the silicon dioxide powder to a silicon dioxide granulate comprises:
providing a liquid;
mixing the pyrogenic silicon dioxide powder with the liquid to obtain a slurry;
granulating the slurry to obtain a silicon dioxide granulate; and
optionally treating the silicon dioxide granulate.

34. The process according to claim 25, wherein at least 90 wt. % of the silicon dioxide granulate is made from the pyrogenic silicon dioxide powder, based on the total weight of the silicon dioxide granulate.

35. The process according to claim 25, wherein the silicon dioxide granulate is characterised by at least one of:
a chlorine content of less than 500 ppm;
an aluminium content of less than 200 ppb;
a BET surface area in a range from 20 to 50 m²/g;
a pore volume in a range from 0.1 to 2.5 mL/g;
a bulk density in a range from 0.5 to 1.2 g/cm³.
a tamped density in a range from 0.7 to 1.2 g/cm³;
a mean particle size in a range from 50 to 500 μm;
a carbon content of less than 5 ppm;
an angle of repose in a range from 23 to 260,
a particle size distribution D₁₀ in a range from 50 to 150 μm;
a particle size distribution D₅₀ in a range from 150 to 300 μm; and
a particle size distribution D₉₀ in a range from 250 to 620 μm,
wherein the ppm and ppb are each based on the total weight of the silicon dioxide granulate II.

36. A quartz glass body obtainable by a process according to claim 25.

37. A quartz glass body containing pyrogenic silicon dioxide, wherein the quartz glass body comprises:
an OH content of less than 10 ppm;
a chlorine content of less than 60 ppm; and
an aluminium content of less than 200 ppb;
wherein the ppb and ppm are each based on the total weight of the quartz glass body.

38. The quartz glass body according to claim 37, wherein the quartz glass body comprises at least one of:
a fictive temperature in a range from 1055 to 1200° C.;
an ODC content of less than 5×10¹⁵/cm³;
a metal content of metals different to aluminium of less than 300 ppb;
a viscosity (p=1013 hPa) in a range from log₁₀ (η (1200° C.)/dPas)=13.4 to log₁₀ (η (1200° C.)/dPas)=13.9 and/or log₁₀ (η (1300° C.)/dPas)=11.5 to log₁₀ (η (1300° C.)/dPas)=12.1 or log₁₀ (η (1350° C.)/dPas)=1.2 to log₁₀ (η (1350° C.)/dPas)=10.8;
a standard deviation of the OH content of not more than 10%, based on the OH content of the quartz glass body;
a standard deviation of the Cl content of not more than 10%, based on the Cl content of the quartz glass body;
a standard deviation of the Al content of not more than 10%, based on the Al content of the quartz glass body;
a refractive index homogeneity of less than 1×10⁻⁴; and
a transformation point Tg in a range from 1150 to 1250° C.;
wherein the ppb and ppm are each based on the total weight of the quartz glass body.

39. A process for the preparation of a formed body comprising:
providing a quartz glass body according to claim 37, or a quartz glass body obtained by a process according to claim 22; and
making a formed body out of the quartz glass body.

40. A formed body obtainable by a process according to claim 39.

41. A process for the preparation of a structure comprising:
providing a formed body according to claim 40 and a part; and
joining the formed body with the part to obtain the structure.

42. A structure obtainable by a process according to claim 41.
